(19) United States
(12) Patent Application Publication
(10) Pub. No.: US 2023/0372870 A1
(43) Pub. Date: Nov. 23, 2023

(54) Tangential Flow Filtration Systems and Methods

(71) Applicant: Sunflower Therapeutics, PBC, Hingham, MA (US)

(72) Inventors: Alexandra Bonnyman, Weymouth, MA (US); John Christopher Love, Somerville, MA (US)

(21) Appl. No.: 18/364,851

(22) Filed: Aug. 3, 2023

Related U.S. Application Data
(60) Provisional application No. 63/429,259, filed on Dec. 1, 2022.

(51) Int. Cl. B01D 61/12; B01D 61/22

(52) U.S. Cl. CPC B01D 61/12; B01D 61/22; B01D 2315/10; B01D 2313/60; B01D 2313/70; B01D 2317/04; B01D 2313/18

(57) ABSTRACT

Disclosed are tangential flow filtration (TFF) systems and methods. A system generally includes a TFF module, a control unit and one or more process-control components. In some cases, a system also includes a feed module. The control unit is electrically connected to the one or more process-control components and is configured to control the process of separation using the one or more process-control components. The systems and methods can maintain constant permeate flow rates to improve the predictability or consistence of the process, automatically switch membranes in case of membrane fouling, automatically promote membrane recovery, and/or permit operation of TFF systems in parallel with other processes in a manufacturing production.

### CROSS-REFERENCE TO RELATED APPLICATION(S)

The present application claims priority to U.S. Provisional Patent Application No. 63/429,259 for filed Dec. 1, 2022. The disclosure of the application is incorporated herein for all purposes by reference in its entirety.

### TECHNICAL FIELD

The present invention generally relates to systems and methods for separation and/or purification of substances by tangential flow membrane filtration.

### BACKGROUND

Tangential flow filtration (TFF) is a separation process that uses membranes to separate components in a solution based on the size, molecular weight or other differences. It has become essential to the separation and purification of target substances, such as proteins or other macromolecules, in the pharmaceutical, vaccine production, alternative protein, and biotechnology industries.

However, conventional TFF systems and methods are typically designed to maintain a constant transmembrane pressure (TMP) throughout the process. As the membrane fouls, the same TMP will result in lower permeate flow rates. Given this change in flow rate, it is hard to predict how long a process will take, or whether the flow rate will be sufficient to complete the task. Moreover, in conventional TFF operations, an entire batch is usually processed through the membrane at once. After processing, the membrane is either discarded or put through an extensive cleaning process, making it impossible to process multiple batches in an automated manner. Further, membrane fouling can occur within a single batch, requiring immediate replacement or cleaning of the membrane and thus causing interruption of the process. In addition, biopharmaceuticals and vaccines are commonly produced using a series of operations and the filtration is only one operation in the series. A feed (i.e., the fluid containing the target substances) is generally produced by other systems and periodically transferred to TFF systems for separation and/or purification. In many cases, operation of TFF systems would be interrupted by this feed transfer.

Hence, there is a need for TFF systems and methods that address the above mentioned issues.

### SUMMARY

Embodiments of the present invention utilize a TFF module, a control unit, one or more process-control components (e.g., regulator, valve, pump, or sensor), and in some cases a feed module, that may be operated to improve the predictability and/or consistency of the process, to automate switching of membranes in case of membrane fouling, to promote membrane recovery in an automated manner, to permit operation of TFF systems in parallel with feed generation without interruption by the feed transfer, or any combination thereof.

In a first aspect, the present invention provides a system including a TFF module, a backpressure regulator, a first sensor and a control unit. The TFF module includes a feed inlet, a retentate outlet, and a permeate outlet. The feed inlet of the TFF module is fluidly connected to an outlet of a first feed unit to receive a feed stream, and the permeate outlet of the TFF module is fluidly connected to a permeate collection module. The backpressure regulator has an inlet fluidly connected to the retentate outlet of the TFF module, and an outlet fluidly connected to an inlet of the first feed unit. The first sensor is configured to measure a flow rate at the permeate outlet of the TFF module. The control unit is electrically connected to the backpressure regulator and the first sensor, and configured to control the backpressure regulator based on the flow rate measured by the first sensor. The control of the backpressure regulator adjusts a transmembrane pressure (TMP) of the TFF module, thereby maintaining a first substantially constant flow rate at the permeate outlet of the TFF module.

In some embodiments, the control of the backpressure regulator increases a pressure at the retentate outlet of the TFF module in response to a decrease of the flow rate measured by the first sensor, or decreases the pressure at the retentate outlet of the TFF module in response to an increase of the flow rate measured by the first sensor. In some embodiments, the control of the backpressure regulator includes altering a set point of the backpressure regulator based on the flow rate measured by the first sensor. In an embodiment, the altering of the set point of the backpressure regulator includes raising the set point in response to the decrease of the flow rate measured by the first sensor, and lowering the set point in response to the increase of the flow rate measured by the first sensor.

In an embodiment, the TFF module consists of a single TFF unit.

In some embodiments, the TFF module includes a plurality of TFF units arranged fluidly in parallel. Each respective TFF unit in the plurality of TFF units includes a corresponding individual feed inlet, a corresponding individual retentate outlet, a corresponding individual permeate outlet, and at least one corresponding valve. The corresponding individual feed inlet is fluidly connected to the feed inlet of the TFF module, the corresponding individual retentate outlet is fluidly connected to the retentate outlet of the TFF module, and the corresponding individual permeate outlet is fluidly connected to the permeate outlet of the TFF module. The at least one corresponding valve includes a corresponding first valve coupled with the corresponding individual feed inlet. The control unit is electrically connected to the at least one corresponding valve of each of the plurality of TFF units, and configured to control the at least one corresponding valve of each of the plurality of TFF units to allow the feed stream to selectively flow through a first set of TFF units in the plurality of TFF units. In addition, the control of the backpressure regulator adjusts the TMP of the first set of TFF units.

In some embodiments, the plurality of TFF units includes two, three, four, five, six, seven, eight, nine, ten or more than ten TFF units.

In some embodiments, for each respective TFF unit in the plurality of TFF units, the at least one corresponding valve further includes a corresponding second valve coupled with the corresponding individual retentate outlet, a corresponding third valve coupled with the corresponding individual permeate outlet, or both.

In an embodiment, the first set of TFF units consists of a single TFF unit to filter the feed stream. In another embodiment, the first set of TFF units includes two or more TFF units, each to filter a portion of the feed stream. In a further embodiment, the first set of TFF units consists of all of the plurality of TFF units.

In some embodiments, the system further includes a second sensor, a plurality of third sensors and a fourth sensor. The second sensor is configured to measure a first pressure at the feed inlet of the TFF module. Each of the plurality of third sensors is configured to measure a corresponding second pressure at a corresponding retentate outlet of a corresponding TFF unit in the plurality of TFF units of the TFF module. The fourth sensor is configured to measure a third pressure at the permeate outlet of the TFF module. The control unit is electrically connected to the second, third and fourth sensor, and is further configured to (i) calculate the TMP of the first set of TFF units based on the measured first pressure, the measured second pressure at the retentate outlet of each TFF unit in the first set of TFF units and the measured third pressures, (ii) determine whether the TMP of the first set of TFF units exceeds a predetermined value, and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units. In an embodiment, a pressure at the retentate outlet of the TFF module is obtained by averaging the second pressures measured at the retentate outlet of each TFF unit in the first set of TFF units.

In some embodiments, the system further includes a second sensor, a third sensor and a fourth sensor. The second sensor is configured to measure a first pressure at the feed inlet of the TFF module, the third sensor is configured to measure a second pressure at the retentate outlet of the TFF module, and the fourth sensor is configured to measure a third pressure at the permeate outlet of the TFF module. The control unit is electrically connected to the second, third and fourth sensors, and is further configured to (i) calculate the TMP of the first set of TFF units based on the first, second and third pressures measured by the second, third and fourth sensors, (ii) determine whether the TMP of the first set of TFF units exceeds a predetermined value, and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

In an embodiment, the control unit is further configured to control the backpressure regulator based on the flow rate measured by the first sensor to adjust a TMP of the second set of TFF units, thereby maintaining a second substantially constant flow rate at the permeate line of the TFF module.

In an embodiment, the second set of TFF units consists of a single TFF unit to filter the feed stream. In another embodiment, the second set of TFF units includes two or more TFF units, each to filter a portion of the feed stream.

In some embodiments, the feed inlet of the TFF module is fluidly connected to the outlet of the first feed unit through a fourth valve, and fluidly connected to an outlet of a buffer module through a fifth valve. The control unit is electrically connected to the fourth valve and the fifth valve and is further configured to control the fourth valve and the fifth valve to draw either the feed stream from the first feed unit or a buffer stream from the buffer module for flowing through the TFF module. In an embodiment, the feed stream and the buffer stream are drawn alternately.

In some embodiments, the system includes a plurality of feed units, and the plurality of feed units includes the first feed unit and a second feed unit. Each respective feed unit in the first and second feed units includes corresponding fourth, fifth, sixth, seventh and eighth valves, the corresponding fourth valve connecting a corresponding individual outlet of the respective feed unit with the feed inlet of the TFF module, the corresponding sixth valve connecting a corresponding individual inlet of the respective feed unit with a source module, the corresponding seventh valve connecting the corresponding individual inlet of the respective feed unit with a buffer module, the corresponding eighth valve connecting the corresponding individual inlet of the respective feed unit with the outlet of the backpressure regulator, and the corresponding fifth sensor configured to measure an amount of a fluid contained in the respective feed unit. The control unit is electrically connected to the corresponding fourth, sixth, seventh and eighth valves and the corresponding fifth sensor of each of the first and second feed units, and configured to (i) determine whether the amount of the fluid contained in the first feed unit is below a predetermined amount, and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

In some embodiments, the control unit is further configured to (iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module. In some embodiments, the control unit is further configured to (iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

In a second aspect, the present invention provides a system including a TFF module, a second sensor, a third sensor, a fourth sensor and a control unit. The TFF module includes a feed inlet, a retentate outlet, a permeate outlet and a plurality of TFF units. The feed inlet of the TFF module is fluidly connected to an outlet of a first feed unit to receive a feed stream, the retentate outlet of the TFF module is fluidly connected to an inlet of the first feed unit, and the permeate outlet of the TFF module is fluidly connected to a permeate collection module. The plurality of TFF units arranged is arranged fluidly in parallel. Each respective TFF unit in the plurality of TFF units includes a corresponding individual feed inlet fluidly connected to the feed inlet of the TFF module, a corresponding individual retentate outlet fluidly connected to the retentate outlet of the TFF module, and a corresponding individual permeate outlet fluidly connected to the permeate outlet of the TFF module. Each respective TFF unit in the plurality of TFF units also includes at least one corresponding valve, and the at least one corresponding valve includes a corresponding first valve coupled with the corresponding individual feed inlet. The second sensor is configured to measure a first pressure at the feed inlet of the TFF module, the third sensor is configured to measure a second pressure at the retentate outlet of the TFF module, and the fourth sensor is configured to measure a third pressure at the permeate outlet of the TFF module. The control unit is electrically connected to the at least one corresponding valve of each of the plurality of TFF units and the second, third and fourth sensors. When the feed stream is flowing through a first set of TFF units in the plurality of TFF units, and the control unit is configured to (i) calculate a TAP of the first set of TFF units based on the first, second and third pressures measured by the second, third and fourth sensors, (ii) determine whether the TAP of the first set of TFF units exceeds a predetermined value, and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

In an embodiment, the first or second set of TFF units consists of a single TFF unit to filter the feed stream. In another embodiment, the first or second set of TFF units includes two or more TFF units, each to filter a portion of the feed stream.

In a third aspect, the present invention provides a system including a TFF module and a control unit. The TFF module includes a feed inlet, a retentate outlet and a permeate outlet. The feed inlet of the TFF module is fluidly connected to an outlet of a first feed unit through a fourth valve to receive a feed stream, and fluidly connected to an outlet of a buffer module through a fifth valve to receive a buffer stream. The retentate outlet of the TFF module is fluidly connected to an inlet of the first feed unit, and the permeate outlet of the TFF module is fluidly connected to a permeate collection module. The control unit is electrically connected to the fourth valve and the fifth valve and is configured to control the fourth valve and the fifth valve to draw either the feed stream from the first feed unit or the buffer stream from the buffer module for flowing through the TFF module.

In some embodiments, the feed stream and the buffer stream are drawn alternately. In an embodiment, the feed stream is flowed through the TFF module for a first time period and the buffer stream is flowed through the TFF module for a second time period. The first and second time periods may or may not be the same. In some embodiments, the feed stream is flowed through the TFF module at a first rate and the buffer stream is flowed through the TFF module at a second rate. The first and second rates may or may not be the same.

In a fourth aspect, the present invention provides a system including a plurality of feed units and a control unit. The plurality of feed units includes a first feed unit and a second feed unit. Each respective feed unit in the first and second feed units includes corresponding fourth, fifth, sixth, seventh, and eighth valves, with the corresponding fourth valve connecting a corresponding individual outlet of the respective feed unit with a feed inlet of a tangential flow filtration (TFF) module, the corresponding sixth valve connecting a corresponding individual inlet of the respective feed unit with a source module, the corresponding seventh valve connecting the corresponding individual inlet of the respective feed unit with a buffer module, the corresponding eighth valve connecting the corresponding individual inlet of the respective feed unit with a retentate outlet of the TFF module, and the corresponding fifth sensor configured to measure an amount of a fluid contained in the respective feed unit. The control unit is electrically connected to the corresponding fourth, sixth, seventh and eighth valves and the corresponding fifth sensor of each of the first and second feed units. When the first feed unit is supplying the feed stream to the TFF module, and the control unit is configured to (i) determine whether the amount of the fluid contained in the first feed unit is below a predetermined amount, and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

In some embodiments, the control unit is further configured to (iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module. In some embodiments, the control unit is further configured to (iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

In a fifth aspect, the present invention provides a method for controlling a system where the system includes a TFF module having a feed inlet fluidly connected to an outlet of a first feed unit to receive a feed stream and a retentate outlet fluidly connected to an inlet of a backpressure regulator. The method includes (A) obtaining a flow rate at a permeate outlet of the TFF module, and (B) controlling the backpressure regulator based on the obtained flow rate to adjust a transmembrane pressure (TMP) of the TFF module, thereby maintaining a substantially constant flow rate at the permeate outlet of the TFF module. In some embodiments, the control (B) of the backpressure regulator includes (B1) altering a set point of the backpressure regulator based on the obtained flow rate. In an embodiment, the altering (B1) of the set point of the backpressure regulator includes raising the set point in response to a decrease of the obtained flow rate, and lowering the set point in response to an increase of the obtained flow rate.

In some embodiments where the TFF module includes a plurality of TFF units arranged fluidly in parallel and each respective TFF unit in the plurality of TFF units includes at least one corresponding valve, the method includes (C) controlling the at least one corresponding valve of each of the plurality of TFF units to allow the feed stream to selectively flow through a first set of TFF units in the plurality of TFF units, and the control (B) of the backpressure regulator adjusts the TMP of the first set of TFF units.

In some embodiments, the method includes (D) obtaining a first pressure at the feed inlet of the TFF module, a second pressure at the retentate outlet of the TFF module, and a third pressure at the permeate outlet of the TFF module, (E) calculating the TMP of the first set of TFF units based on the first, second and third pressures, (F) determining whether the TMP of the first set of TFF units exceeds a predetermined value, and (G) controlling, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

In some embodiments where the feed inlet of the TFF module is fluidly connected to the outlet of the first feed unit through a fourth valve, and fluidly connected to an outlet of a buffer module through a fifth valve, the method includes (H) controlling the fourth valve and the fifth valve to draw either the feed stream from the first feed unit or a buffer stream from the buffer module for flowing through the TFF module.

In some embodiments where the TFF module is fluidly connected to a plurality of feed units, the plurality of feed units including the first feed unit and a second feed unit, and each respective feed unit in the first and second feed units is fluidly connected to the TFF module, a source module and a buffer module through a plurality of corresponding valves, the method include (I) determining whether an amount of a fluid contained in the first feed unit is below a predetermined amount, and (J) controlling, if it is determined that the amount of the fluid contained in the first feed unit is below the predetermined amount, the plurality of corresponding valves of each of the first and second feed units to draw the feed stream from the second feed unit in the plurality of feed units. In some embodiments, the method further include (K) controlling, if it is determined that the amount of the fluid contained in the first feed unit is below the predetermined amount, the plurality of corresponding valves of each of the first and second feed units to flush the first feed unit with a buffer stream from the buffer module. In some embodiments, the method further include (L) controlling, if it is determined that the amount of the fluid contained in the first feed unit is below the predetermined amount, the plurality of corresponding valves of each of the first and second feed units to replenish the first feed unit with a feed fluid from the source module.

In a sixth aspect, the present invention provides a method for controlling a system where the system includes a TFF module having a plurality of TFF units arranged fluidly in parallel, each respective TFF unit in the plurality of TFF units includes at least one corresponding valve, a feed inlet of the TFF module is fluidly connected to an outlet of a first feed unit to receive a feed stream that is flowing through a first set of TFF units in the plurality of TFF units. The method include (A) obtaining a first pressure at the feed inlet of the TFF module, a second pressure at a retentate outlet of the TFF module, and a third pressure at a permeate outlet of the TFF module, (B) calculating the TMP of the first set of TFF units based on the first, second and third pressures, (C) determining whether the TMP of the first set of TFF units exceeds a predetermined value, and (D) controlling, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

In a seventh aspect, the present invention provides a method for controlling a system where the system includes a TFF module having a feed inlet fluidly connected to an outlet of a first feed unit through a fourth valve to receive a feed stream and fluidly connected to an outlet of a buffer module through a fifth valve to receive a buffer stream. The method includes controlling the fourth valve and the fifth valve to draw either the feed stream from the first feed unit or the buffer stream from the buffer module for flowing through the TFF module.

In an eight aspect, the present invention provides a method for controlling a system where the system includes a plurality of feed units having a first feed unit and a second unit, each respective feed unit in the first and second feed units is fluidly connected to a TFF module, a source module and a buffer module through a plurality of corresponding valves, and the first feed unit is supplying a feed stream to the TFF module. The method includes (A) determining whether an amount of a fluid contained in the first feed unit is below a predetermined amount, and (B) controlling, if it is determined that the amount of the fluid contained in the first feed unit is below the predetermined amount, the plurality of corresponding valves of each of the first and second feed units to draw the feed stream from a second feed unit in the first and second feed units. In some embodiments, the method further includes (C) controlling, if it is determined that the amount of the fluid contained in the first feed unit is below the predetermined amount, the plurality of corresponding valves of each of the first and second feed units to flush the first feed unit with a buffer stream from the buffer module. In some embodiments, the method further includes (D) controlling, if it is determined that the amount of the fluid contained in the first feed unit is below the predetermined amount, the plurality of corresponding valves of each of the first and second feed units to replenish the first feed unit with a feed fluid from the source module.

The systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The foregoing summary, as well as the following detailed description of exemplary embodiments, will be better understood when read in conjunction with the appended drawings of exemplary embodiments. It should be understood, however, that the invention is not limited to the precise arrangements and instrumentalities shown.

In the drawings:

FIG. 1 is a block diagram illustrating a tangential flow filtration (TFF) system in accordance with some exemplary embodiments of the present invention;

FIGS. 2A and 2B are block diagrams illustrating exemplary TFF modules in accordance with some exemplary embodiments of the present invention;

FIGS. 3A and 3B are block diagrams illustrating exemplary feed modules in accordance with some exemplary embodiments of the present invention;

FIG. 4 is a block diagram illustrating an exemplary control unit in accordance with some exemplary embodiments of the present invention;

FIG. 5 is a block diagram illustrating a first exemplary TFF system in accordance with some exemplary embodiments of the present invention;

FIG. 6 is a flowchart illustrating a first exemplary method, in which the preferred parts of the method are shown in solid line boxes whereas additional, optional, or alterative parts of the method are shown in dashed line boxes, in accordance with some exemplary embodiments of the present invention;

FIG. 7 is a graph showing some experimental results in accordance with some exemplary embodiments of the present invention;

FIG. 8 is a block diagram illustrating a second exemplary TFF system in accordance with some exemplary embodiments of the present invention;

FIGS. 9A and 9B are flowcharts collectively illustrating a second exemplary method, in which the preferred parts of the method are shown in solid line boxes whereas additional, optional, or alterative parts of the method are shown in dashed line boxes, in accordance with some exemplary embodiments of the present invention;

FIG. 10 is a graph showing some experimental results in accordance with some exemplary embodiments of the present invention;

FIG. 11 is a block diagram illustrating a third exemplary TFF system in accordance with some exemplary embodiments of the present invention;

FIG. 12 is a flowchart illustrating a third exemplary method, in which the preferred parts of the method are shown in solid line boxes whereas additional, optional, or alterative parts of the method are shown in dashed line boxes, in accordance with some exemplary embodiments of the present invention;

FIG. 13 is a block diagram illustrating a fourth exemplary TFF system in accordance with some exemplary embodiments of the present invention;

FIG. 14 is a flowchart illustrating a fourth exemplary method, in which the preferred parts of the method are shown in solid line boxes whereas additional, optional, or alterative parts of the method are shown in dashed line boxes, in accordance with some exemplary embodiments of the present invention; and

FIG. 15 is a block diagram illustrating a fourth exemplary TFF system in accordance with some exemplary embodiments of the present invention.

### DETAILED DESCRIPTION

### Introduction and Definition

The present invention is directed to systems and methods for separation and/or purification of substances by tangential flow membrane filtration. A system of the present invention generally includes a tangential flow filtration (TFF) module and a control unit. The TFF module includes one or more TFF units and is configured for separating a feed stream into a retentate stream and a permeate stream. The control unit is configured to monitor and/or control the process of separation. In some embodiments, additionally or optionally, a system of the present invention includes a feed module having one or more feed units (e.g., container, vessel, tank, bag) to provide a feed stream to the TFF module. In some embodiments, a system of the present invention is fluidly connected to one or more external modules such as a source module, a buffer module or both, and configured to draw a fluid (e.g., a feed or buffer fluid) from the one or more external modules when desired.

In various embodiments, the process of separation is controlled to (i) maintain a substantially constant permeate flow rate so that process timings are more predictable and/or more consistent, (ii) automatically switch to other TFF unit(s) if the current TFF unit(s) is fouled so that the process can be continued without interruption, (iii) initiate a buffer stream to the TFF module to promote membrane recovery so that a TFF unit (e.g., a membrane of the TFF unit) can be used for more than one batch, (iv) automatically switch and replenish feed units so that the process of feed separation can be operated in parallel (e.g., concurrently or overlapping) with a process of feed generation (e.g., a process occurred in the source module) regardless of their cyclic frequencies, or (v) any combination thereof.

Before the invention is described in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order that is logically possible.

As used in the description of the implementations and the appended claims, the singular forms “a”, “an” and “the” are intended to include the plural forms as well, unless the context clearly indicates otherwise. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

The term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “i^{th}” denotation, the reference number refers to a generic component, set, or embodiment. For instance, a “unit i” refers to the i^{th} unit in a plurality of units.

The term “tangential flow filtration unit” or “TFF unit” used herein refers to a unit that includes a filtration membrane for separating components in a liquid solution or suspension on the basis of size, molecular weight or other differences. In particular, the term “tangential flow filtration unit” or “TFF unit” used herein refers to a unit where when a feed stream passes parallel to the filtration membrane, a portion of the feed stream passes through the filtration membrane (permeate) while a portion of the feed stream retained by the filtration membrane (retentate). A TFF unit has a feed inlet, a retentate outlet and a permeate outlet. Examples of filtration membranes include, but are not limited to, ultrafiltration (UF) membranes, microfiltration (MF) membranes, reverse osmosis (RO) membranes and nanofiltration (NF) membranes. The UF membranes refer to membranes that have pore sizes in the range of between about 1 nanometer to about 100 nanometers. The MF membranes refer to membranes that have pore sizes in the range between about 0.1 micrometers to about 10 micrometers.

The term “tangential flow filtration module” or “TFF module” used herein refers to a module that includes one or more TFF units. In embodiments where the TFF module consists of a single TFF unit, the TFF module is the TFF unit, or can be used interchangeably with the TFF unit. In embodiments where the TFF module includes a plurality of TFF units, the TFF units in the TFF module are fluidly connected to each other in parallel. That is, the feed inlets of the TFF units are fluidly connected to each other and collectively define an feed inlet of the TFF module, the retentate outlets of the TFF units are fluidly connected to each other and collectively define a retentate outlet of the TFF module, and the permeate outlets of the TFF units are fluidly connected to each other and collectively define a permeate outlet of the TFF module. The TFF units of a TFF module can be, but do not necessarily have to be, identical. For instance, two different TFF units in the same TFF module can have the same configuration (e.g., size, shape, membrane type) or different configurations.

The term “feed” or “feed fluid” used herein refers to a solution with one or more compounds of interest. Examples of a compound of interest include, but are not limited to proteins, salts, chemicals, or other pharmaceutical ingredients.

The term “feed stream” used herein refers to the feed or feed fluid that is delivered or to be delivered to a TFF module for filtration or separation. Delivery of a feed stream can be continuously, intermittently, as a batch, or the like.

The terms “filtration” and “separation” used herein generally refer to the act of using a membrane or membranes to separate a feed stream into a permeate stream and a retentate stream.

The terms “permeate” and “permeate stream” used herein refer to the portion of the solution that has permeated through a membrane or membranes.

The terms “retentate” and “retentate stream” used herein refer to the portion of the solution that has been retained by a membrane or membranes. The retentate or the retentate stream is enriched in a retained species.

The term “feed unit” used herein refers to a unit (e.g., container, vessel, tank, bag or the like) configured to hold a certain amount of a fluid that needs to be fed to a filtration module (e.g., a TFF module) for separation. A feed unit includes an inlet and an outlet.

The term “feed module” used herein refers to a module that includes one or more feed units. In embodiments where the feed module consists of a single feed unit, the feed module is the feed unit, or can be used interchangeably with the feed unit. In embodiments where the feed module includes multiple feed units, the feed units can be, but do not necessarily have to be, identical. For instance, two different feed units in the same feed module can have the same configuration (e.g., size, shape, type) or different configurations.

The term “fluidly connected” used herein refers to two or more components (e.g., a TFF unit and a feed unit, two or more TFF units, feed inlets of two or more TFF units, etc.) connected by one or more conduits such that a fluid can flow from one component to another. The fluidic connection between two components can be direct, i.e., there is no other component between the two components except the conduit(s) that connects the two components. The fluidic connection between two components can also be indirect, i.e., there is at least one component between the two components in addition to the conduit(s) that connects the two components. For instance, in some embodiments, a feed inlet of a TFF unit is fluidly connected to an outlet of a feed unit, with a pump and at least one valve disposed in the flow path between the feed inlet of the TFF unit and the outlet of the feed unit. In some embodiment, an retentate outlet of a TFF module is fluidly connected to an inlet of a feed module, with a backpressure regulator disposed in the flow path between the TFF module and the feed module.

The term “electrically connected” used herein refers to two or more components (e.g., a control unit and a sensor) connected by wire or wireless (e.g., using a cable or a network) such that electrical signals can flow from one component to another.

The term “transmembrane pressure of a TFF unit” or “TMP of a TFF unit” used herein refers to the difference in pressure between two sides of a membrane of the TFF unit. It is the force that drives the permeate stream through the membrane and can be calculated by determining the difference from the average feed pressure and the permeate pressure using equation (1):

$${P}_{TMP} = \frac{{P}_{f} + {P}_{r}}{2} - {P}_{p} .$$

In equation (1), P_{TMP} represents the transmembrane pressure of the TFF unit, P_{f} represents the pressure of the feed stream at the feed inlet of the TFF unit, Pᵣ represents the pressure of the retentate stream at the retentate outlet of the TFF unit, and Pₚ represents the pressure of the permeate stream at the permeate stream of the TFF unit.

The term “transmembrane pressure of a TFF module” or “TMP of a TFF module” used herein refers to the pressure difference calculated using equation (2):

$${P}_{TMP}^{′} = \frac{P {′}_{f} + P {′}_{r}}{2} - {P}_{p}^{′} .$$

In equation (2), P′_{TMP} represents the transmembrane pressure of the TFF module, P′_{f} represents the pressure of the feed stream at the feed inlet of the TFF module, P′ᵣ represents the pressure of the retentate stream at the retentate outlet of the TFF module, and P′ₚ represents the pressure of the permeate stream at the permeate stream of the TFF module. In embodiments where the TFF module consists of a single TFF unit, the TMP of the TFF module is generally the same as the TMP of the TFF unit. In embodiments where the TFF module includes a plurality of TFF units, the TMP of the TFF module may or may not be the same as each of the plurality of TFF units, due to the use of valves and/or other components.

The term “batch” used herein refers to a certain amount of the feed fluid that needs to be fed to the TFF module for separation or a certain period of time during which a feed stream is continuously fed to the TFF module for separation.

### Overview of the Systems and Methods

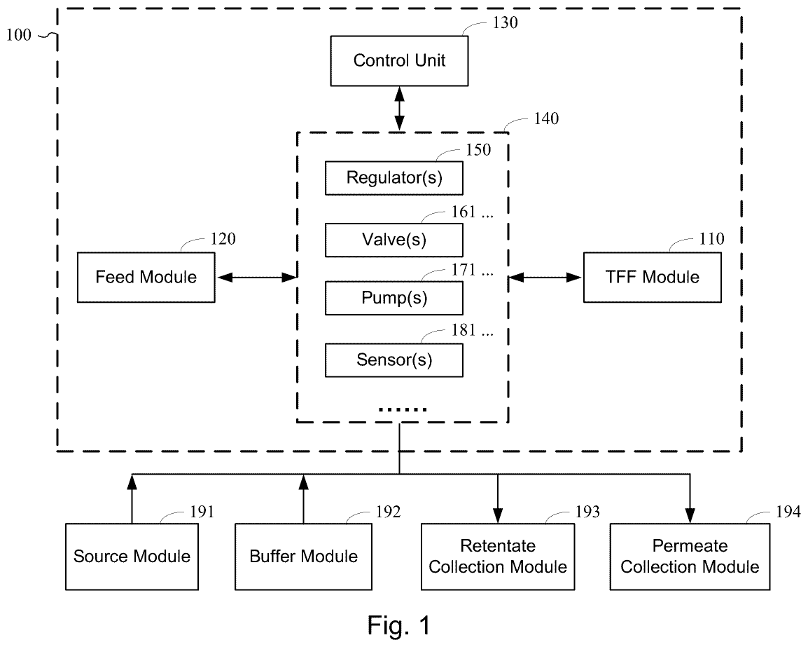

FIG. 1 illustrates an exemplary system, generally designated 100, in accordance with some exemplary embodiments of the present invention. The system 100 includes a tangential flow filtration (TFF) module 110, a control unit 130, and in some cases, a feed module 120. The TFF module 110 is fluidly connected to the feed module 120 to receive a feed stream from the feed module 120 and to separate the feed stream into a permeate stream and a retentate stream. In some embodiments, additionally and optionally, the system 100 includes one or more process-control components 140 disposed in one or more flow paths in the system 100, e.g., a flow path between the feed module and the TFF module, a flow path between the feed module and a module external to the system 100, or a flow path between the TFF module and a module external to the system 100. The one or more process-control components 140 include, but are not limited to, one or more regulators 150, one or more valves 161, etc., one or more pumps 171, etc., one or more sensors 181, etc., or any combination thereof.

The control unit 130 is electrically connected to one or more process-control components 140 and is configured to control the process of separation using the one or more process-control components 140. In some embodiments, the control unit 130 monitors one or more sensors, e.g., obtaining measurement data from one or more sensors repeatedly, and controls the process based on the measurement data. In some embodiments, the control unit obtains measurement data from one or more sensors at a rate of every 60 seconds or less, every 50 seconds or less, every 40 seconds or less, every 30 seconds or less, every 25 seconds or less, every 20 seconds or less, every 15 seconds or less, every 10 seconds or less, every 5 seconds or less, every 4 seconds or less, every 3 seconds or less, every 2 seconds or less, or every 1 second or less. The rate to obtain measurement data may be constant or varied during the process.

In some embodiments, the system 100 is fluidly connected to a source module 191, a buffer module 192, a retentate collection 193, a permeate collection module 194, or any combination thereof. The source module 191 is configured to provide a feed fluid to the feed module 120. The source module 191 can be a module that generates the feed fluid, a reservoir that stores the feed fluid, or the like. The buffer module is configured to provide a buffer fluid for cleansing, conditioning, or priming the TFF module 110 and/or the feed module 120, or the like. The buffer module includes different types of buffer fluids and the system 100 is configured to selectively draw any buffer fluid from the buffer module depending on the application and/or the stage of the process. In some embodiments, the buffer module is configured to perform other function(s) or provide other buffer fluid(s). The retentate collection module 193 and the permeate collection module 194 are configured to receive the retentate stream and the permeate stream from the system, respectively. In some embodiments, the retentate stream contains the compound(s) of interest. Alternatively, in some embodiments, the permeate stream contains the compound(s) of interest.

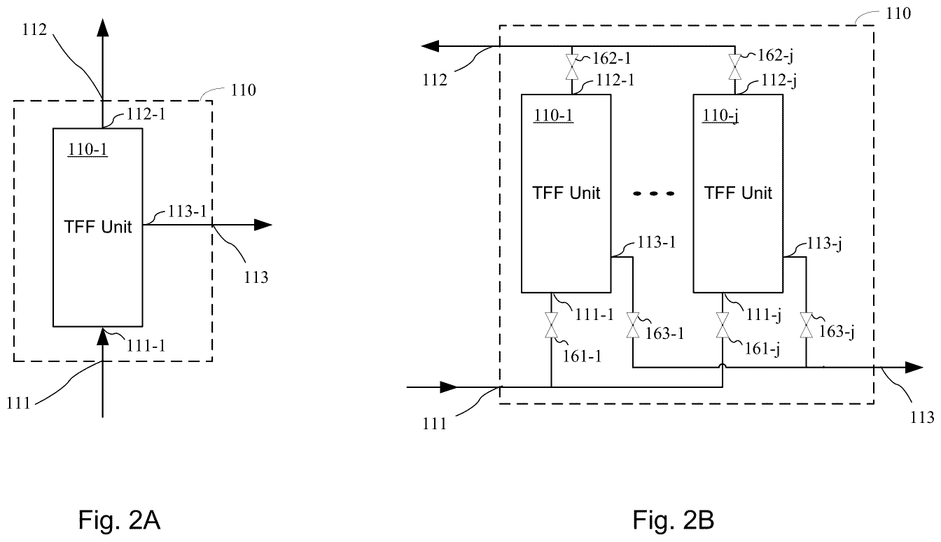

The TFF module 110 can include any suitable number of TFF units. For instance, in some embodiments, the TFF module 110 consists of a single TFF unit, e.g., the TFF unit 110-1 as illustrated in FIG. 2A. In such embodiments, the TFF module is the TFF unit, or can be used interchangeably with the TFF unit because anything that flows into the TFF module will flow into the TFF unit and anything that flows out of the TFF unit will flow out of the TFF module. For instance, in the illustrated embodiment, anything that flows through the feed inlet 111 of the TFF module 110 will flow through the feed inlet 111-1 of the TFF unit 110-1. Anything that flows out of the retentate outlet 112-1 of the TFF unit 110-1 will flow out of the retentate outlet 112 of the TFF module 110, and anything that flows out of the permeate outlet 113-1 of the TFF unit 110-1 will flow out of the permeate outlet 113 of the TFF module 110.

In some embodiments, the TFF module 110 includes a plurality of TFF units, e.g., 2, 3, 4, 5, 6, 7, 8, 9, 10 or more than 10 TFF units. By way of example, FIG. 2B illustrates the TFF module 110 includes a TFF unit 110-1, . . . and a TFF unit 110-j, where j is an integer equal to or greater than 2. The TFF units in the plurality of TFF units are fluidly connected with each other in parallel. That is, the feed inlets 111-1, . . . , 111-j of the TFF unit 110-1, . . . 110-j are fluidly connected to each other and collectively define a common feed inlet 111 of the TFF module 110. Similarly, the retentate outlet 112-1, . . . , 112-j of the TFF unit 110-1, . . . 110-j are fluidly connected to each other and collectively define a common retentate outlet 112 of the TFF module 110. The permeate outlet 113-1, . . . , 113-j of the TFF unit 110-1, . . . 110-j are fluidly connected to each other and collectively define a common permeate outlet 113 of the TFF module 110.

In some embodiments, a valve is disposed in a flow path between the feed inlet of an individual TFF unit and the feed inlet of the TFF module 110. For instance, a valve 161-1 is disposed in the flow path between the feed inlet 111-1 of the TFF unit 110-1 and the feed inlet 111 of the TFF module 110. A valve 161-j is disposed in the flow path between the feed inlet 111-j of the TFF unit 110-j and the feed inlet 111 of the TFF module 110. Additionally or optionally, a valve is disposed in a flow path between the retentate outlet of an individual TFF unit and the retentate outlet 112 of the TFF module 110. For instance, an additional or optional valve 162-1 is disposed in the flow path between the retentate outlet 112-1 of the TFF unit 110-1 and the retentate outlet 112 of the TFF module 110. An additional or optional valve 162-j is disposed in the flow path between the retentate outlet 112-j of the TFF unit 110-j and the retentate outlet 112 of the TFF module 110. Additionally or optionally, a valve is disposed in a flow path between the permeate outlet of an individual TFF unit and the permeate outlet 113 of the TFF module 110. For instance, an additional or optional valve 163-1 is disposed in the flow path between the permeate outlet 113-1 of the TFF unit 110-1 and the permeate outlet 113 of the TFF module 110. An additional or optional valve 163-j is disposed in the flow path between the permeate outlet 113-j of the TFF unit 110-j and the permeate outlet 113 of the TFF module 110.

Any one of the TFF units or any group of the TFF units can be used selectively and independently to separate a feed stream regardless of the presence or absence of any other TFF units. This can be achieved by using the control unit 130 to control the operation of the valve(s). For instance, in an embodiment, one TFF unit (e.g., the TFF unit 110-1, the TFF unit 110-2 or the like) is selected and used to separate a feed stream at a time. In another embodiment, a group of the TFF units (e.g., two TFF units, three TFF units, or the like) are selected and used simultaneously to separate a feed stream at a time. When two or more TFF units are used simultaneously, each TFF unit is operated to filter a portion of the feed stream. For instance, in embodiments where the TFF unit 110-1 and the TFF unit 110-2 are used for separation, the TFF unit 110-1 is used to filter a first portion of the feed stream while the TFF unit 110-2 is used to filter a second portion of the feed stream. The first and second portions can be the same, e.g., each TFF unit filtering about 50% of the feed stream. The first and second portions can also be different, e.g., one TFF unit filtering more than 50% of the feed stream and the other TFF unit filtering less than 50% of the feed stream. Using a group of TFF units instead of a single TFF unit generally increases the capacity of separation, resulting in a higher permeate flow rate and shorter processing time. In a further embodiment, when desired or necessary, all of the TFF units are used simultaneously to separate a feed stream at a time.

Similarly, the feed module 120 can include any suitable number of feed units, e.g., any suitable number of containers, vessels, bags or the like, that are configured to hold a certain amount of a fluid that needs to be fed to the TFF module 110 for separation. In some embodiments, a feed unit has a capacity to hold a fluid at an amount of from about 1 liter (L) to about 5 L, from about 3 L to about 10 L, from about 5 L to about 15 L, from about 10 L to 20 L, from about 15 L to 25 L, from about 20 L to about 30 L, from about 25 L to 35 L, from about 30 L to about 40 L, from about 35 L to 45 L, or from about 40 L to about 50 L. In some embodiments, a feed unit has a capacity to hold a fluid at an amount of more than 5 L, more than 10 L, more than 20 L, more than 30 L, more than 40 L, more than 50 L, more than 60 L, more than 70 L, more than 80 L, more than 90 L, or more than 100 L. In some embodiments, a feed unit has a capacity to hold a fluid at an amount of more than 100 L, more than 200 L, more than 300 L, more than 400 L, or more than 500 L. In some embodiments, a feed unit has a capacity to hold a fluid at an amount less than 5 L, less than 4 L, less than 3 L, less than 2 L, or less than 1 L.

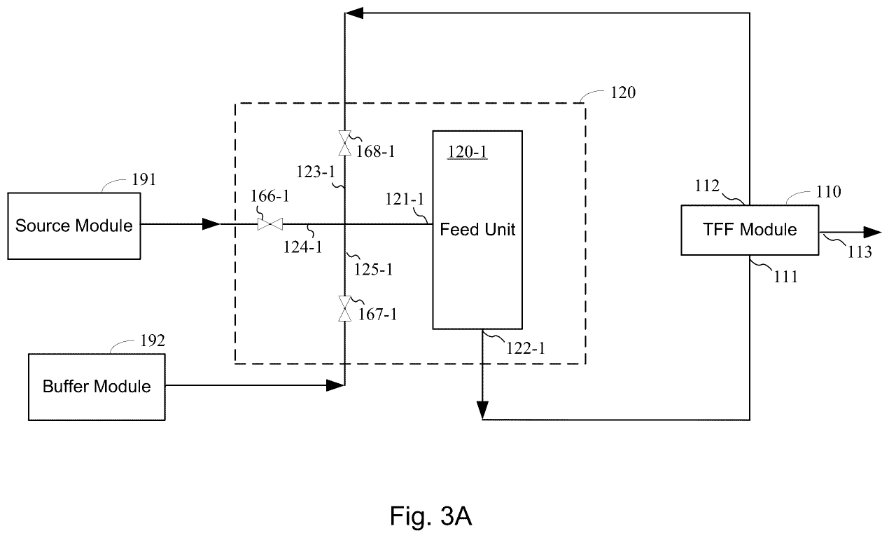

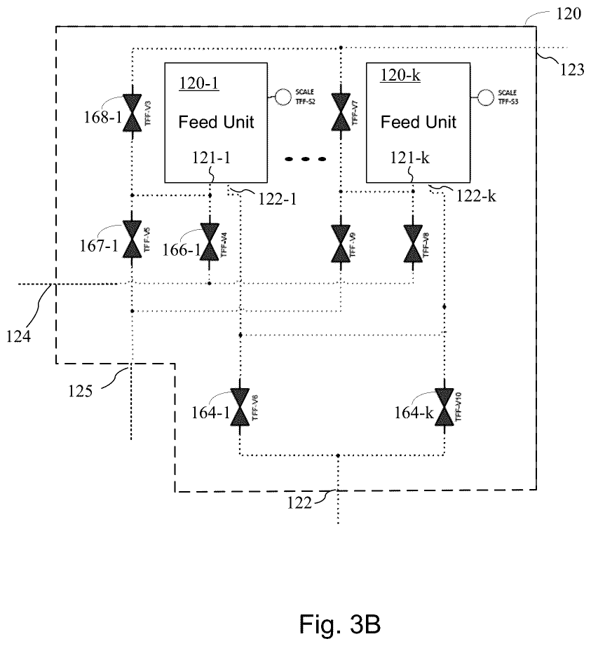

In some embodiments, the feed module 120 consists of a single feed unit, e.g., the feed unit 120-1 as illustrated in FIG. 3A. In such embodiments, the feed module is the feed unit, or can be used interchangeably with the feed unit. The feed unit 120-1 has an inlet 121-1 fluidly connected to the retentate outlet 112 of the TFF module 110 and an outlet 122-1 fluidly connected to the feed inlet 111 of the TFF module 110. In some embodiments, the inlet 121-1 of the feed unit 120-1 is fluidly connected to one or more components external to the system 100, such as the source module 191, the buffer module 192, or both. The system 100 may draw a feed liquid from the source module 191 to replenish the feed unit 120-1, or a buffer stream from the buffer module 192 to cleanse, condition or prime the feed unit 120-1, or the like. In other words, the inlet 121-1 of the feed unit 120-1 is branched to two, three, four or more branches. As a non-limiting example, it is illustrated that the inlet 121-1 of the feed unit 120-1 is branched to three branches, with a retentate inlet-branch 123-1 fluidly connected to the retentate outlet 112 of the TFF module 110, a source inlet-branch 124-1 fluidly connected to the source module 191, and a buffer inlet-branch 125-1 fluidly connected to the buffer module 192.

In some embodiments, a valve 168-1 is disposed in a flow path between the retentate inlet-branch 123-1 and the retentate outlet 112 of the TFF module 110. A valve 166-1 is disposed in a flow path between the source inlet-branch 124-1 and the source module 191. A valve 167-1 is disposed in a flow path between the buffer inlet-branch 125-1 and the buffer module 192. The control unit 130 is electrically connected to the valves and is configured to control the operation of the valves to selectively allow the retentate stream from the TFF module, the feed fluid from the source module, or the buffer stream from the buffer module to flow into the feed unit 120-1.

In some embodiments, the feed module 120 includes a plurality of feed units, e.g., 2, 3, 4, 5, 6, 7, 8, 9, 10 or more than 10 feed units. By way of example, FIG. 3B illustrates the feed module 120 includes a feed unit 120-1, . . . and a feed unit 120-k, where k is an integer equal to or greater than 2. Each feed unit has an inlet 121-m (m=1, . . . , k) and an outlet 122-m. In some embodiments, the inlet of at least one feed unit in the feed module is branched for fluidly connecting the at least one feed unit to the retentate outlet of the TFF module as well as one or more components external to the system 100 such as the source module 191 and/or the buffer module 192. In some embodiments, the inlet of each feed unit in the feed module is branched. By way of example, FIG. 3B illustrates that the inlet of each of the feed unit 120-1 and the feed unit 120-k is branched to three inlet-branches: a retentate inlet branch, a source inlet-branch and a buffer inlet-branch.

In some embodiments, the outlets of the plurality of feed units are fluidly connected to each other and collectively define an outlet 122 of the feed module 120. A valve is disposed in a flow path between the outlet of an individual feed unit and the outlet of the feed module. For instance, a valve 164-1 is disposed in the flow path between the outlet 122-1 of the feed unit 120-1 and the outlet 122 of the feed module. A valve 164-k is disposed in the flow path between the outlet 122-k of the feed unit 120-k and the outlet 122 of the feed module.

In some embodiments, the retentate inlet-branches of the plurality of feed units are fluidly connected to each other and collectively define a retentate inlet-branch 123 of the feed module. Similarly, the source inlet-branches of the plurality of feed units are fluidly connected to each other and collectively define a source inlet-branch 124 of the feed module. The buffer inlet-branches of the plurality of feed units are fluidly connected to each other and collectively define a buffer inlet-branch 125 of the feed module. A valve (e.g., the valve 168-1) is disposed in a flow path between the retentate inlet-branch (e.g., the retentate inlet-branch 123-1) of an individual feed unit (e.g., the feed unit 120-1) and the retentate inlet-branch 123 of the feed module. A valve (e.g., the valve 166-1) is disposed in a flow path between the source inlet-branch (e.g., the source inlet-branch 124-1) of an individual feed unit (e.g., the feed unit 120-1) and the source inlet-branch 124 of the feed module. A valve (e.g., the valve 167-1) is disposed in a flow path between the buffer inlet-branch (e.g., the buffer inlet-branch 125-1) of an individual feed unit (e.g., the feed unit 120-1) and the buffer inlet-branch 125 of the feed module.

Any one of the feed units can be used selectively and independently to provide a feed stream to the TFF module 110 regardless of the presence or absence of any other feed units. Selection of a feed unit can be achieved by using the control unit 130 to control the operation of the corresponding valves.

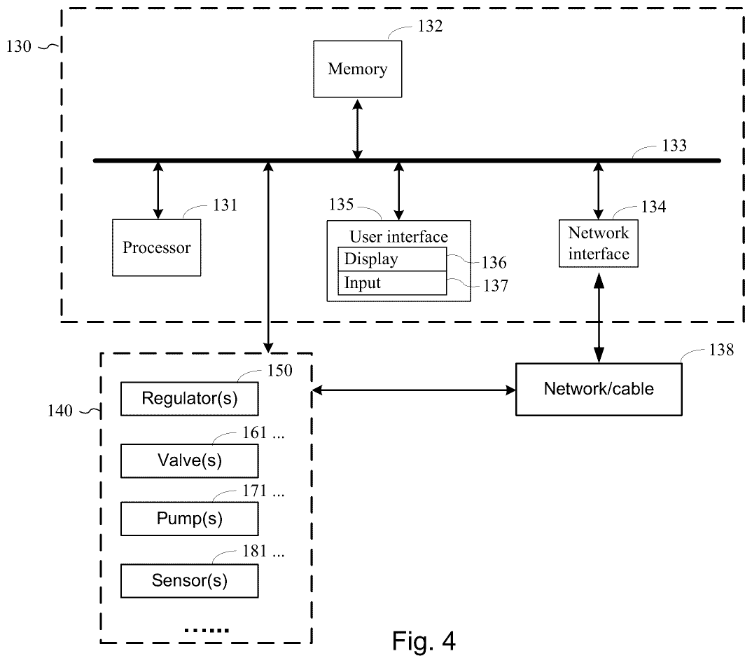

Referring to FIG. 4, the control unit 130 is configured to control the process of separation using the one or more process-control components 140. The control unit 130 includes one or more processors 131, a memory 132, and one or more communication busses 133 interconnecting the processor(s) and memory. The memory stores one or more programs configured to be executed by the one or more processors. The memory 132 may include random access memory, such as RAM, DRAM, SRAM, DDR RAM, or other random access solid state memory devices, and optionally may also include non-volatile memory, such as one or more magnetic disk storage devices, optical disk storage devices, flash memory devices, or other non-volatile solid state storage devices. The memory 132 may optionally include one or more storage devices remotely located from the processor(s) 131. The memory 132, or alternatively the non-volatile memory device(s) within memory 132, may include a non-transitory computer readable storage medium. In some embodiments, the memory 132 may include mass storage that is remotely located with respect to the processor(s) 131. In other words, some data stored in memory 132 may in fact be hosted on devices that are external to the control unit 130, but that can be electronically accessed by the control unit 130 over a network/cable 138 (e.g., an Internet, intranet, electronic cable or the like) using a communication interface 134.

In some embodiments, additionally or optionally, the control unit 130 may include a user interface 135. The user interface 135 typically includes a display device 136 for presenting data, receiving instructions (e.g., the display device including a touch-sensitive surface), or both. In some embodiments, the user interface 135 includes an optional input device 137, such as a keyboard, a mouse or the like, for receiving instructions. The user interface 135 may be an integral part of the control unit 130. Alternatively, the user interface 135 may be a part external to the control unit 130 but can be accessed by the control unit 130 over the network/cable 138 using the communication interface 134.

The control unit 130 may be electrically connected to the one or more process-control components 140 through the one or more communication busses 133, through the communication interface 134 and the network/cable 138, or both. For instance, in an embodiment, the control unit 130 is electrically connected to each of the one or more process-control components 140 through the one or more communication busses 133. In another embodiment, the control unit 130 is electrically connected to each of the one or more process-control components 140 through the communication interface 134 and the network/cable 138. In a further embodiment, the control unit 130 is electrically connected to at least one of the one or more process-control components 140 through the one or more communication busses 133 and to at least one of the one or more process-control components 140 through the communication interface 134 and the network/cable 138.

In some embodiments, the systems and methods of the present invention are configured to maintain a substantially constant permeate flow rate, e.g., maintaining a substantially constant flow rate at the permeate outlet 113 of the TFF module 110. This is typically achieved by adjusting a transmembrane pressure (TMP) of the TFF module. As such, process timings are more predictable and/or more consistent.

In some embodiments, the systems and methods of the present invention are configured to automatically switch to other TFF unit(s) if the current TFF unit(s) is fouled. This is typically achieved by monitoring a pressure required to reach a certain permeate flow rate through the membrane(s) of a TFF unit or a group of TFF units. When this pressure exceeds a specified limit, indicating the membrane(s) is fouled to a point where it will not be able to process the feed stream (e.g., the next batch of the feed fluid), the systems and methods automatically start using other available TFF unit(s) for separation. As a result, the process can be continued without interruption or delay.

In some embodiments, the systems and methods of the present invention are configured to initiate a buffer stream through a TFF unit or a group of TFF units to promote membrane recovery. A buffer stream is typically initiated after a small batch of the feed fluid is processed through the membrane(s) of the TFF unit(s), and if necessary, can continue until the next batch of the feed fluid is ready to be processed. As a result, the membrane(s) can be used to process more than one batch of the feed fluid.

In some embodiments, the systems and methods of the present invention are configured to automatically switch feed units to permit parallel processing of feed generation and feed separation. This is typically achieved by directing the feed fluid from the source module 191 to a second feed unit (e.g., the feed unit 120-2) while critical operations (e.g., concentration or diafiltration) of separation involve a first feed unit (e.g., the feed unit 120-1). In some embodiments, after critical operations of separation are completed using the first feed unit, the first feed unit is flushed with a buffer stream (e.g., one or more priming fluids) to remove residual material from the previous cycle and prepared to receive the feed fluid again. Similarly, while critical operations of separation involve the second feed unit, the feed fluid from the source module 191 is directed to the first feed unit. As a result, the process of feed separation can be operated in parallel (e.g., concurrently or overlapping) with the process of feed generation (e.g., a process occurred in the source module 191) whether their cyclic frequencies are the same or different.

Now that the general systems and methods have been described, exemplary systems and methods for separation and/or purification of substances will be described.

### First Exemplary System and Method

The permeate flow rate depends on several factors, including but not limited to the composition of the material being processed, the flow rate of the feed stream, the number of TFF unit(s) being used for separation, the characteristics of the TFF unit(s) being used for separation, and the transmembrane pressure (TMP) of the selected TFF unit(s). In general, as a feed stream or a portion of it flows through a TFF unit, feed components (e.g., retentate) will gradually build up on the membrane surface of the TFF unit. This will affect the membrane's filtration effectiveness and cause membrane fouling. When the membrane fouls, the same TMP will result in slower permeate flow rates. Given this change in flow rate, it is hard to predict how long a process will take.

Accordingly, the present invention provides a first exemplary system 500 and method 600 for controlling a permeate flow rate in accordance with some embodiments of the present disclosure. The system 500 and method 600 are configured to maintain a substantially constant permeate flow rate so that process timings are more predictable and/or more consistent.

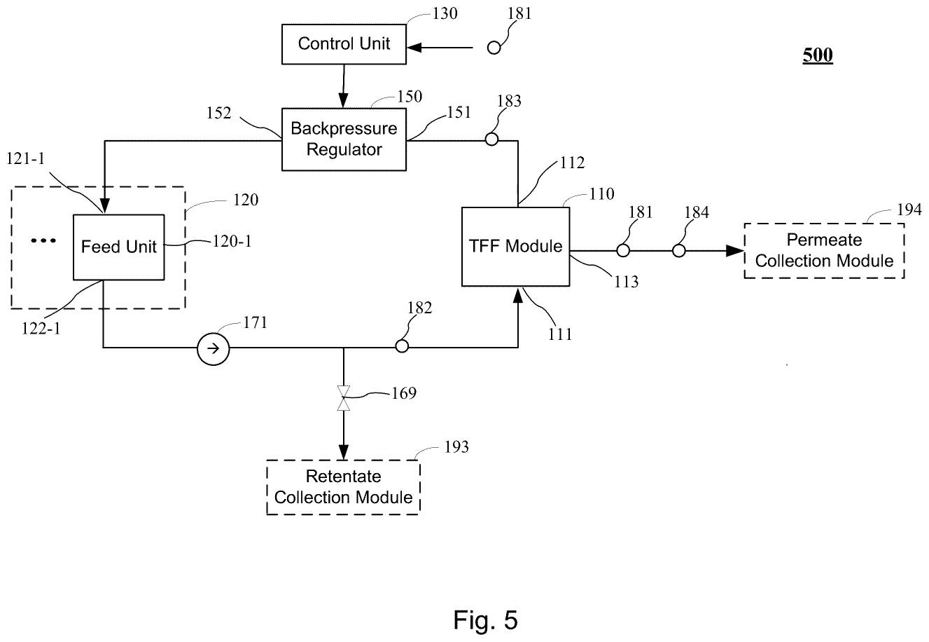

Referring to FIG. 5, the system 500 includes a TFF module 110, a control unit 130, a backpressure regulator 150, and a first sensor 181. The TFF module 110 can consist of a single TFF unit, such as the TFF unit 110-1 as illustrated in FIG. 2A and disclosed herein. The TFF module 110 can also include a plurality of TFF units, such as those illustrated in FIG. 2B and disclosed herein. The feed inlet 111 of the TFF module is fluidly connected to an outlet 122-1 of a feed unit 120-1 of a feed module 120 to receive a feed stream. In some embodiments, the feed inlet 111 of the TFF module is fluidly connected to the outlet 122-1 of the feed unit 120-1 through a pump 171. That is, the pump 171 (e.g., a feed pump) is disposed in a flow path between the feed inlet 111 of the TFF module and the outlet 122-1 of the feed unit 120-1. The pump 171 is operated, for instance, by the control unit 130, to draw a feed stream from the feed unit 120-1 and direct the drawn feed stream to the TFF module. In some embodiments, the outlet of the feed unit 120-1 or the corresponding individual outlet of each respective feed unit of the feed module 120 is connected to a retentate collection module 193 by a valve 169. In such embodiments, the valve 169 and pump 171 may be operated, for instance, by the control unit 130, to direct the feed stream to the retentate collection module.

The permeate outlet 113 of the TFF module is fluidly connected to a permeate collection module 194. The retentate outlet 112 of the TFF module is fluidly connected to an inlet 151 of the backpressure regulator 150, which has an outlet 152 fluidly connected to an inlet 121-1 of the feed unit 120-1. The first sensor 181 is configured to measure a flow rate at the permeate outlet 113 of the TFF module. The first sensor 181 can be positioned physically at or adjacent to the permeate outlet 113 of the TFF module. The first sensor 181 can also be positioned physically away from the permeate outlet 113 of the TFF module, for instance, at a conduit that is fluidly connected to the permeate outlet 113 of the TFF module, or the first sensor being a non-contact or non-invasive sensor.

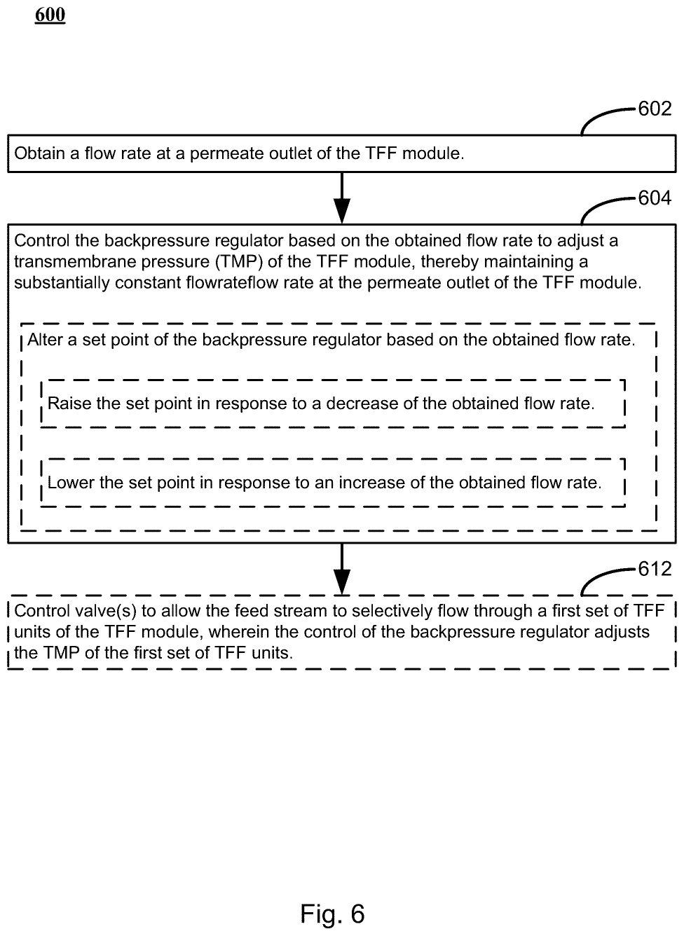

The control unit 130 is configured to maintain a substantially constant permeate flow rate so that process timings are more predictable and/or more consistent. To do so, the control unit 130 is electrically connected to the backpressure regulator 150 and the first sensor 181. The control unit 130 obtains, as illustrated at block 602 in FIG. 6, a flow rate at a permeate outlet of the TFF module, e.g., obtaining the flow rate measured by the first sensor 181. Based on the obtained flow rate, the control unit 130 controls the backpressure regulator 150 to adjust the TMP of the TFF module as illustrated at block 604. Adjusting the TMP of the TFF module changes the TMP of each selected TFF unit that is currently being used for separation. In turn, the changing in the TMP of each selected TFF unit changes permeation through the membrane of each selected TFF unit. As a result, adjusting the TMP of the TFF module changes the permeate flow rate at the permeate outlet of the TFF module.

In some embodiments, the control unit 130 controls the backpressure regulator 150 to increase the pressure (e.g., P′ᵣ) at the retentate outlet 122 of the TFF module. The increase of the pressure (e.g., P′ᵣ) at the retentate outlet 122 of the TFF module increases the pressure (e.g., Pᵣ) at the retentate outlet (e.g., the retentate outlet 112-1) of each selected TFF unit (e.g., the TFF unit 110-1) being used for separation. The increase of the pressure at the retentate outlet of each selected TFF unit increases the TMP of the selected TFF unit (e.g., P_{TMP}), which drives more fluid through the membrane and consequently increases the permeate flow rate. Conversely, in response to an increase of the flow rate measured by the first sensor 181, the control unit 130 controls the backpressure regulator 150 to decrease the pressure (e.g., P′ᵣ) at the retentate outlet 122 of the TFF module. The decrease of the pressure (e.g., P′ᵣ) at the retentate outlet 122 of the TFF module decreases the pressure (e.g., Pᵣ) at the retentate outlet (e.g., the retentate outlet 112-1) of each selected TFF unit (e.g., the TFF unit 110-1) being used for separation. The decrease of the pressure at the retentate outlet of each selected TFF unit decreases the TMP of the selected TFF unit, which drives less fluid through the membrane and consequently decreases the permeate flow rate. As a result, the permeate flow rate at the permeate outlet of the TFF module is maintained at a substantially constant flow rate, and consequently, the process timing is more predictable and/or more consistent.

In some embodiments, the control of the backpressure regulator 150 to increase or decrease the pressure at the retentate outlet of the TFF module is achieved by altering a set point of the backpressure regulator 150. The set point of the backpressure regulator 150 defines the pressure upstream of its own inlet, which corresponds to the pressure at the retentate outlet of the TFF module. In an embodiment, in response to the decrease of the flow rate measured by the first sensor 181, the control unit 130 raises the set point of the backpressure regulator 150 and thus increases the pressure (e.g., P′ᵣ) at the retentate outlet of the TFF module, resulting in an increase of the permeate flow rate. Conversely, in response to the increase of the flow rate measured by the first sensor 181, the control unit 130 lowers the set point of the backpressure regulator 150 and thus decreases the pressure (e.g., P′ᵣ) at the retentate outlet of the TFF unit module, resulting in a decrease of the permeate flow rate.

In some embodiments, the control unit 130 is configured to monitor the flow rate measured by the first sensor 181. For instance, in an embodiment, the control unit 130 obtains the flow rate from the first sensor at a rate of every 60 seconds or less, every 50 seconds or less, every 40 seconds or less, every 30 seconds or less, every 25 seconds or less, every 20 seconds or less, every 15 seconds or less, every 10 seconds or less, every 5 seconds or less, every 4 seconds or less, every 3 seconds or less, every 2 seconds or less, or every 1 second or less. Based on the obtained flow rates, the control unit 130 determines whether the measured flow rate is varied comparing to a preset flow rate or the flow rate measured during the previous time period. The control unit 130 then controls the backpressure regulator 150, based on whether and how the measured flow rate is varied, to adjust the TMP of the TFF module and thus maintain a substantially constant permeate flow rate.

Referring to block 612, in some embodiments where the TFF module includes a plurality of TFF units, the control unit 130 is configured to control the valve(s) to allow the feed stream to selectively flow through a first set of TFF units of the TFF module. For instance, in the embodiment illustrated in FIG. 2B, the control unit is electrically connected to the valves of each of the plurality of TFF units, i.e., the valves 161-1, . . . , 161-j, and if present, the additional/optional valves 162-1, . . . , 162-j and additional/optional valve 163-1, . . . , 163-j. The control unit 130 controls the operation (e.g., open, close or the like) of these valves to allow the feed stream to selectively flow through a first set of TFF units in the plurality of TFF units.

In some embodiments, the first set of TFF units consists of a single TFF unit, e.g., the TFF unit 110-1, to filter the feed stream. In some embodiments, the first set of TFF units includes two or more TFF units, each to filter a portion of the feed stream. For instance, in an embodiment, the first set of TFF units includes two TFF units, e.g., the TFF unit 110-1 and the TFF unit 110-2. The TFF unit 110-1 filters a first portion and the TFF unit 110-2 filters a second portion of the feed stream. The first and second portions of the feed stream can be the same (e.g., each about 50%) or different (e.g., one greater than 50% and the other less than 50%). In some embodiments, the first set of TFF units consists of all TFF units. Comparing to a single TFF unit, simultaneous use of multiple TFF units generally increases the permeate flow rate at the permeate outlet of the TFF module and reduces the process time for separation.

In some embodiments, additionally or optionally, the system 500 includes a second sensor 182, a third sensor 183 and a fourth sensor 184. The second sensor 182 is configured to measure a first pressure (e.g., P′_{f}) at the feed inlet 111 of the TFF module. The third sensor 183 is configured to measure a second pressure (e.g., P′ᵣ) at the retentate outlet 112 of the TFF module. The fourth sensor 184 is configured to measure a third pressure (e.g., P′ₚ) at the permeate outlet 113 of the TFF module. The control unit 130 is electrically connected to the second, third and fourth sensors, and is configured to calculate, for instance, using equation (2) disclosed herein, the TMP of the module based on the pressures measured by the second, third and fourth sensors.

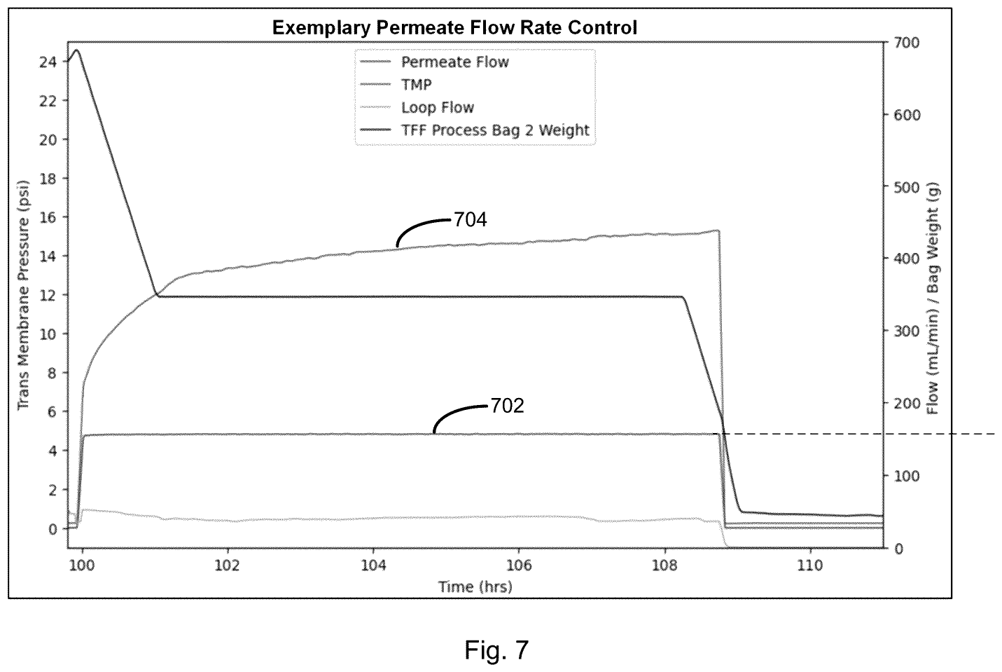

FIG. 7 shows some experimental results that verify the effectiveness of the permeate flow rate control. In FIG. 7, the line 702 (i.e., the line in pink) shows the permeate flow rate measured at the permeate outlet of the TFF module. The line 704 (i.e., the line in green) shows the TMP of the TFF module calculated based on the pressures measured by the second, third and fourth sensors. As shown, the TMP of the TFF module is increased with time and the permeate flow rate is maintained at a substantially constant of about 155 mL/min over a period of about 9 hours. This is achieved by controlling the backpressure regulator 150.

### Second Exemplary System and Method

Each membrane has an ideal TMP based on its material composition and/or the composition of the fluid used in processing. However, as tangential flow filtration involves the recirculation of the feed, feed components build up on the membrane's surface and increase the TMP. When this TMP exceeds a specified limit, the membrane will not be able to properly process a feed stream and membrane fouling occurs. Correcting membrane fouling generally requires cleaning or replacing the membrane. As such, the process of separation has to be paused until the membrane is cleaned or replaced.

Accordingly, the present invention provides a second exemplary system 800 and method 900 for automatically switching TFF units for separation in accordance with some exemplary embodiments of the present invention. The system 800 and method 900 are configured to automatically switch to other TFF unit(s) for separation if the current TFF unit(s) is fouled so that the process can be continued without interruption or delay.

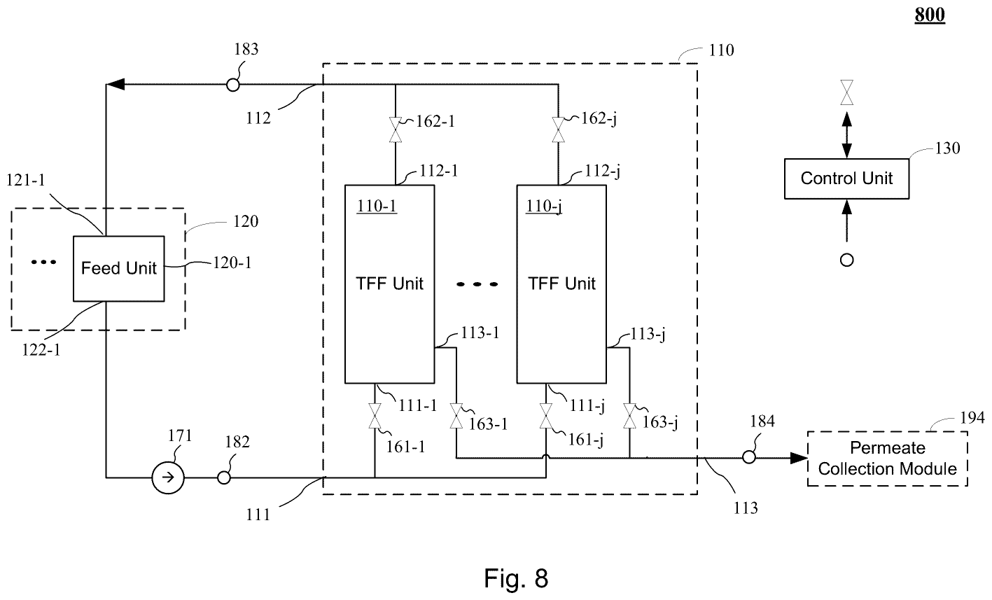

Referring to FIG. 8, the system 800 includes a TFF module 110, a control unit 130, a second sensor 182, a third sensor 183 and a fourth sensor 184. The feed inlet 111 of the TFF module is fluidly connected to an outlet 122-1 of a feed unit 120-1 of a feed module 120 to receive a feed stream. The retentate outlet 112 of the TFF module is fluidly connected to an inlet 121-1 of the feed unit 120-1. The permeate outlet 113 of the TFF module is fluidly connected to a permeate collection module 194. The second sensor 182 is configured to measure a first pressure (e.g., P′_{f}) at the feed inlet 111 of the TFF module. The third sensor 183 is configured to measure a second pressure (e.g., P′ᵣ) at the retentate outlet 112 of the TFF module. The fourth sensor 184 is configured to measure a third pressure (e.g., P′ₚ) at the permeate outlet 113 of the TFF module.

The TFF module includes a plurality of TFF units, e.g., the TFF unit 110-1, . . . , 110-j, where j is an integer equal to or greater than 2. The TFF units in the plurality of TFF units are arranged fluidly in parallel, i.e., the feed inlet (e.g., the feed inlet 111-1) of each individual TFF unit (e.g., the TFF unit 110-1) is fluidly connected to the feed inlet 111 of the TFF module, the retentate outlet (e.g., the retentate outlet 112-1) of each individual TFF unit (e.g., the TFF unit 110-1) is fluidly connected to the retentate outlet 112 of the TFF module, and the permeate outlet (e.g., the permeate outlet 113-1) of each individual TFF unit (e.g., the TFF unit 110-1) is fluidly connected to the permeate outlet 113 of the TFF module. Each of the plurality of TFF units includes at least one valve. For instance, each of the plurality of TFF units includes a valve coupled with its individual feed inlet, e.g., a valve 161-1 coupled with the feed inlet 111-1 of the TFF unit 110-1 and a valve 161-j coupled with the feed inlet 111-j of the TFF unit 110-j. In some embodiments, each of the plurality of TFF units include one or more additional or optional valve(s). For instance, in some embodiments, each of the plurality of TFF units includes an additional/optional valve coupled with its individual retentate outlet, e.g., a valve 162-1 coupled with the retentate outlet 112-1 of the TFF unit 110-1 and a valve 162-j coupled with the retentate outlet 112-j of the TFF unit 110-j. In some further embodiments, each of the plurality of TFF units includes an additional/optional valve coupled with its individual permeate outlet, e.g., a valve 163-1 coupled with the permeate outlet 113-1 of the TFF unit 110-1 and a valve 163-j coupled with the permeate outlet 113-j of the TFF unit 110-j. The presence of the additional/optional valves allows better or more precise control of the process.

The control unit 130 is electrically connected to the second, third and fourth sensors, and the valve(s) of each of the plurality of TFF units. Based on the pressures measured by the second, third and fourth sensors, the control unit controls the operation of the valve(s) of each of the plurality of TFF units.

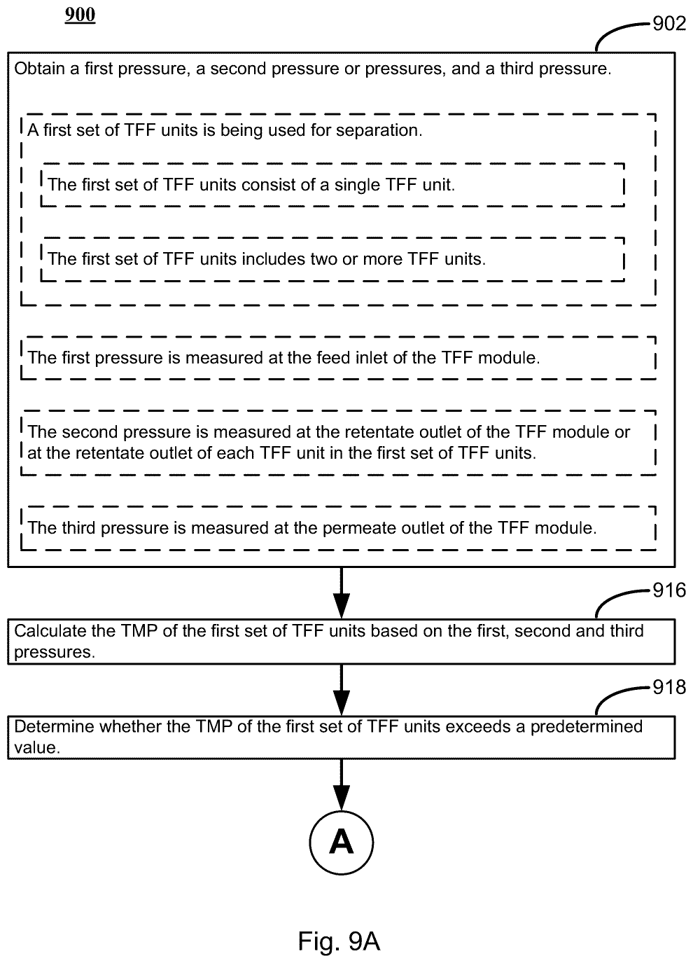

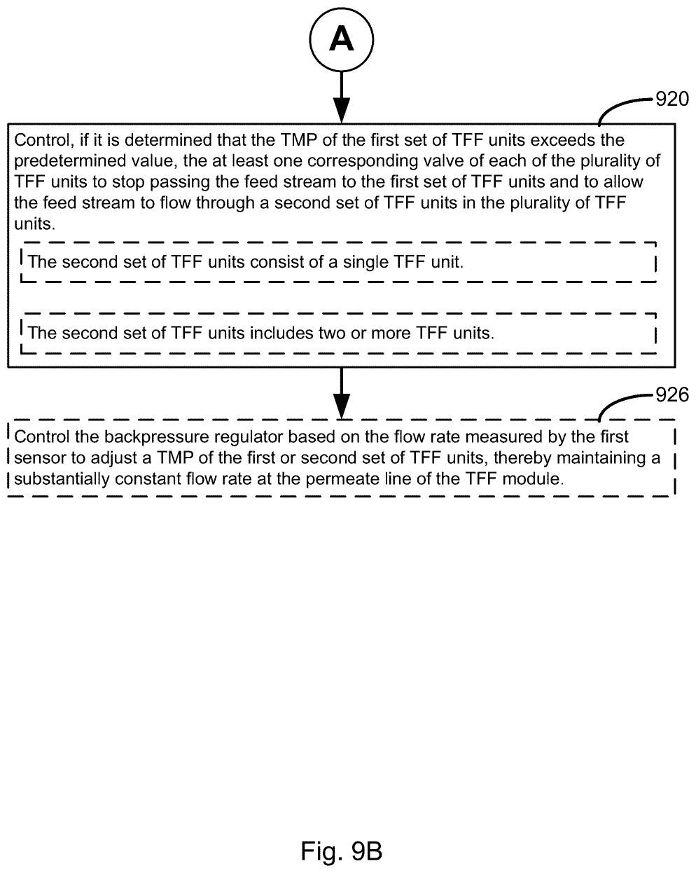

For instance, referring to block 902 in FIG. 9A, in some embodiments, a first set of TFF units in the plurality of TFF units is being used for separation, e.g., the valve(s) of the TFF unit(s) in the first set is open while the valve(s) of the remaining TFF unit(s) is closed. The first set of TFF units can consist of a single TFF unit or include multiple TFF units (e.g., 2, 3, 4 or more that 4 TFF units). In embodiments where multiple TFF units are used, each of the multiple TFF units filters a portion of the feed stream, and the portions of the feed stream through different TFF units can be the same or different.

The control unit 130 obtains first, second and third pressures. For instance, in some embodiments, the control unit 130 obtains the first pressure (e.g., P′_{f}) at the feed inlet 111 of the TFF module from the second sensor 182, the second pressure (e.g., P′ᵣ) at the retentate outlet 112 of the TFF module from the third sensor 183, the third pressure (e.g., P′ₚ) at the permeate outlet 113 of the TFF module from the fourth sensor 184. In some embodiments, alternative or additional to having one third sensor 183 measure the second pressure at the retentate outlet 112 of the TFF module, the system includes a plurality of third sensors, each configured to measure a corresponding second pressure (e.g., Pᵣ) at a corresponding retentate outlet of a corresponding TFF unit in the plurality of TFF units. For instance, the system includes a third sensor to measure a second pressure at the retentate outlet 112-1 of the TFF unit 110-1 and another third sensor to measure a second pressure at the retentate outlet 112-j of the TFF unit 110-j. The control unit 130 obtains the first pressure (e.g., P′_{f}), the corresponding second pressure (e.g., Pᵣ) at the retentate outlet of each TFF unit in the first set of TFF units, and the third pressure (e.g., P′ₚ).

Referring to block 916, the control unit 130 calculates, for instance, using equation (2) disclosed herein, the TMP (e.g., P′ₚ) of the TFF module based on the first, second and third pressures measured by the second, third and fourth sensors. Since the feed inlet, retentate outlet and permeate outlet of each individual TFF are fluidly connected to the feed inlet, retentate outlet and permeate outlet of the TFF module, the TMP of the TFF module reflects the TMP of the first set of TFF units or the TMP of each individual TFF unit in the first set of TFF units. In some embodiments, alternatively, the control unit 130 calculates the TMP of the first set of TFF units based on the measured first pressure, the measured third pressures, and the measured second pressure at the retentate outlet of each TFF unit in the first set of TFF units. In some embodiments, the control unit 130 calculates an average of the measured second pressures at the retentate outlets of the first set of TFF units and assigns this average as the second pressure at the retentate outlet of the TFF module.

Referring to block 918, once the TMP of the TFF module or the TMP of the first set of TFF units is calculated, the control unit 130 determines whether the TMP of the TFF module or the TMP of the first set of TFF units exceeds a predetermined value. The predetermined value may be set by a personnel (e.g., a person in charge of the system/process, or the like), for instance, using the input device 137, or may be determined based on the characteristics of the TFF units in the TFF module.

Referring to block 920 in FIG. 9B, if it is determined that the TMP of the TFF module or the TMP of the first set of TFF units exceeds the predetermined value, the control unit 130 controls the valve(s) of each of the plurality of TFF units to stop passing the feed stream to the first set of TFF units and to allow the feed stream to flow through a second set of TFF units in the plurality of TFF units. Like the first set of TFF units, the second set of TFF units can consist of a single TFF unit or include multiple TFF units (e.g., 2, 3, 4 or more that 4 TFF units). For instance, in an embodiment, the TFF unit 110-1 is the first set of TFF units being used for separation. If it is determined that the TMP of the TFF module exceeds the predetermined value, the control unit 130 closes the valve(s) of the TFF unit 110-1 to stop passing the feed stream to the TFF unit 110-1, and opens the valve(s) of the TFF unit 110-2 to allow the feed stream to flow through the TFF unit 110-2.

Referring to block 926, in some embodiments, the system 800 includes a backpressure regulator and a first sensor, such as the backpressure regulator 150 and the first sensor 181 illustrated in FIG. 5 and disclosed herein. In such embodiments, when the first set of TFF units is being used for separation, the control unit 130 controls the backpressure regulator based on the flow rate measured by the first sensor to adjust a TMP of the first set of TFF units and thus maintain a first substantially constant flow rate at the permeate line of the TFF module until the TMP of the first set of TFF units exceeds the predetermined value. Similarly, after switching to the second set of TFF units, the control unit 130 controls the backpressure regulator based on the flow rate measured by the first sensor to adjust a TMP of the second set of TFF units and thus maintains a second substantially constant flow rate at the permeate line of the TFF module until the TMP of the second set of TFF units exceeds the predetermined value.

It should be noted that the predetermined value for determining whether the first set of TFF units is fouled and the predetermined value for determining whether the second set of TFF units is fouled can be the same or different. For instance, in embodiments where the first and second sets of TFF units include identical TFF units, the same predetermined value may be used for determining whether the first set of TFF units is fouled and whether the second set of TFF units is fouled. In embodiments where the first and second sets of TFF units include different TFF units (e.g., different sizes, types, etc.), different predetermined values may be used for determining whether the first set of TFF units is fouled and whether the second set of TFF units is fouled.

Similarly, it should be note that the first substantially constant flow rate at the permeate line of the TFF module to be maintained when the first set of TFF units is used for separation and the second substantially constant flow rate at the permeate line of the TFF module to be maintained when the second set of TFF units is used for separation can be the same or different. For instance, in embodiments where the first and second sets of TFF units include the same number of identical TFF units, the first substantially constant flow rate and second substantially constant flow rate may be the same. A non-limiting example is an embodiment with two identical TFF units where each of the first and second sets has one identical TFF unit. In embodiments where the first and second sets of TFF units include different TFF units or different numbers of TFF units, the first substantially constant flow rate and second substantially constant flow rate may be different. A non-limiting example is an embodiment with three identical TFF units where one of the first and second sets has one identical TFF units and the other of the first and second sets has two identical TFF units.

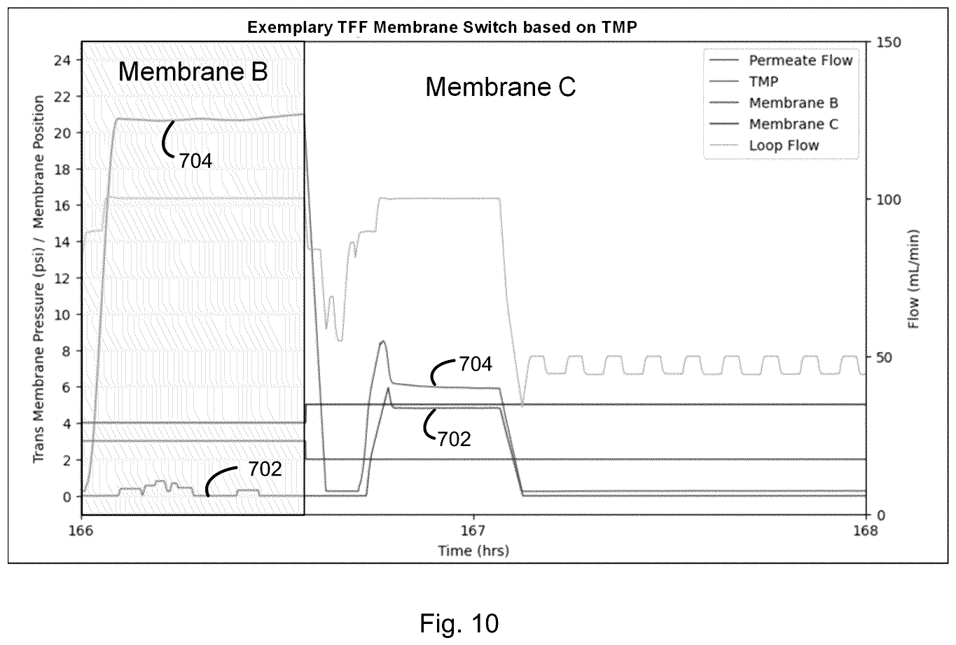

FIG. 10 shows some experimental results where the process of separation is switched from a TFF unit having a membrane B to a TFF unit having a membrane C. In FIG. 10, the line 702 (i.e., the line in pink) shows the permeate flow rate measured at the permeate outlet of the TFF module. The line 704 (i.e., the line in green) shows the TMP of the TFF module calculated based on the pressures measured by the second, third and fourth sensors. As shown, at a point of time when the TFF unit having membrane B is being used for separation, the TMP of the TFF module reaches a high level of about 21 pounds per square inch (psi) but does not produce a meaningful permeate flow. This indicates that the membrane B is fouled and is no longer suitable for filtering the feed stream. Accordingly, the system automatically switches to the TFF unit having the membrane C for separation. As can be seen, switching to the TFF unit having the membrane C lowers the TMP of the TFF module to about 6 psi, which produces a permeate flow rate of about 30 mL/min.

### Third Exemplary System and Method

In conventional TFF operations, a big batch (e.g., a large amount of feed fluid) is processed through a membrane at once. After processing, the membrane is either discarded or put through an extensive cleaning process. This is not suitable for TFF processing of multiple small batches because it is not possible to do conventional cleaning in an automated manner between these small batches.

Accordingly, the present invention provides a third exemplary system 1100 and method 1200 for promoting membrane recovery in accordance with some exemplary embodiments of the present invention. The system 1100 and method 1200 are configured to initiate a buffer stream to promote membrane recovery after a small batch of the feed fluid is processed. The buffer stream removes feed components (e.g., retentate) built up on the membrane surface and rejuvenates the membrane. As a result, the membrane can be used to process more than one batch of the feed fluid.

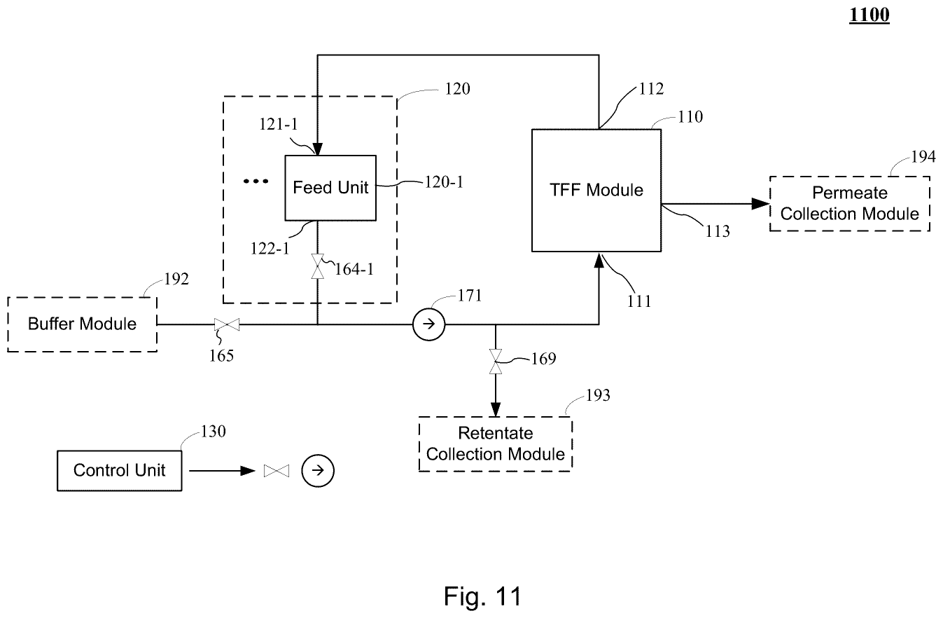

Referring to FIG. 11, the system 1100 includes a TFF module 110 and a control unit 130. The retentate outlet 112 of the TFF module is fluidly connected to an inlet 121-1 of the feed unit 120-1. The permeate outlet 113 of the TFF module is fluidly connected to a permeate collection module 194. The feed inlet 111 of the TFF module is fluidly connected to an outlet 122-1 of a feed unit 120-1 of a feed module 120 to receive a feed stream, and to an outlet of a buffer module 192 to receive a buffer stream. In some embodiments, the feed inlet 111 of the TFF module is fluidly connected to the outlet 122-1 of the feed unit 120-1 through a valve 164-1 disposed in the flow path between the outlet 122-1 of the feed unit 120-1 and the feed inlet 111 of the TFF module. Similarly, the feed inlet 111 of the TFF module is fluidly connected to the outlet of the buffer module 192 through a valve 165 disposed in the flow path between the outlet of the buffer module 192 and the feed inlet 111 of the TFF module. In some embodiments, the pump 171 is disposed in a common flow path between the feed inlet 111 of the TFF module and the outlet 122-1 of the feed unit 120-1 and between the feed inlet 111 of the TFF module and the outlet of the buffer module. The control unit 130 is electrically connected to the valve 164-1, the valve 165 and the pump 171, and is configured to control the operation of the valve 164-1, the valve 165 and the pump 171.

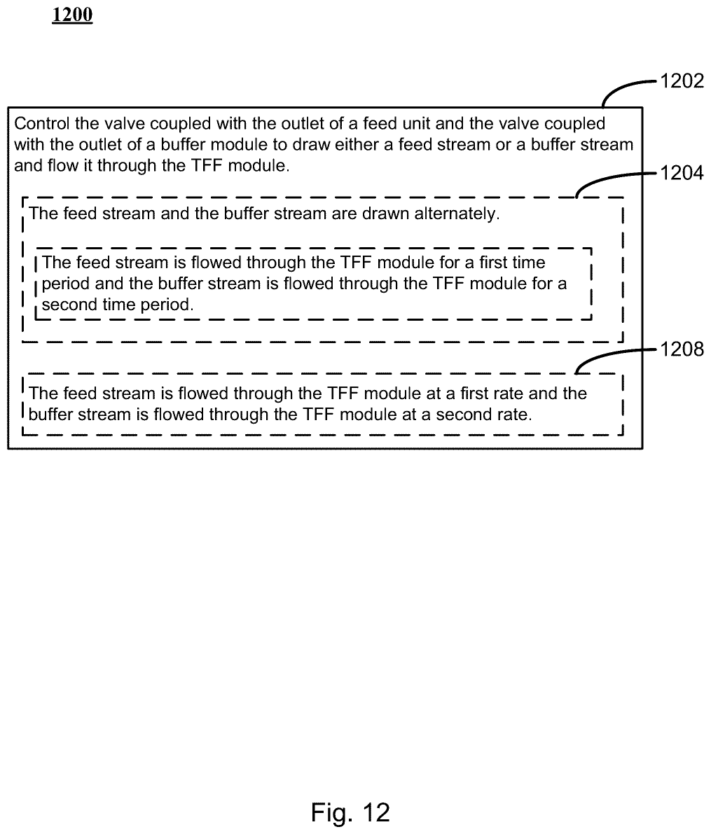

Referring to block 1202 in FIG. 12, the control unit 130 is configured to control the operation of the valve 164-1 and the valve 165 so that the system can draw either a feed stream from the feed unit 120-1 or a buffer stream from the buffer module 192 and flow it through the TFF module. For instance, when a small batch of the feed fluid (e.g., the amount of the feed fluid contained in the feed unit 120-1, or a portion of the feed fluid contained in the feed unit 120-1) has been processed, the control unit 130 closes the valve 164-1 and opens the valve 165 to draw a buffer stream from the buffer module and flow the buffer stream through the TFF module. When the membrane(s) is recovered or when a next batch of the feed fluid is ready to be processed, the control unit 130 closes the valve 165 to stop drawing the buffer stream from the buffer module.

Referring to block 1204, in some embodiments, the feed stream and the buffer stream are drawn alternately. For instance, the feed stream is drawn and flowed through the TFF module for a first time period and the buffer stream is drawn and flowed through the TFF module for a second time period. Typically, the first time period is less than 50 hours, less than 45 hours, less than 40 hours, less than 35 hours, less than 30 hours, less than 25 hours, less than 20 hours, less than 15 hours, less than 10 hours, less than 8 hours, less than 6 hours, less than 5 hours, less than 4 hours, less than 3 hours, less than 2 hours, or less than 1 hours. The second time period is more than 10 hours, more than 15 hours, more than 20 hours, more than 25 hours, more than 1 day, or more than 2 days.

The first or second time period may be set or adjusted by a personnel (e.g., a person in charge of the system/process, or the like). In some embodiments, the system 1100 includes the first sensor 181 that measures a flow rate at the permeate outlet 113 of the TFF module, and/or the second sensor 182, third sensor 183 and fourth sensor 184 that measure the pressures at the feed inlet 111, retentate outlet 112 and permeate outlet 113 of the TFF module. In such embodiments, the control unit 130 may be configured to determine or adjust the first or second time period based on the measured permeate flow rate and/or measured pressures. For instance, in an embodiment, when the permeate flow rate obtained from the first sensor is below a certain level or when the TAP of the TFF module calculated based on the measured pressures exceeds a certain value, the control unit 130 closes the valve 164-1 to stop drawing a feed stream from the feed unit 120-1, and opens the valve 165 to start drawing a buffer stream from the buffer module.

Referring to block 1208, in some embodiments, the feed stream is flowed through the TFF module at a first rate and the buffer stream is flowed through the TFF module at a second rate. The first or second rate may be constant or varied over a period of time. Typically, the first rate is higher than 25 mL/min, higher than 50 mL/min, higher than 100 mL/min, higher than 200 mL/min, higher than 300 mL/min, higher than 400 mL/min, higher than 500 mL/min, higher than 1000 mL/min, higher than 2000 mL/min, higher than 3000 mL/min, higher than 4000 mL/min, or higher than 5000 mL/min. The second rate is lower than 500 mL/min, lower than 400 mL/min, lower than 300 mL/min, lower than 250 mL/min, lower than 200 mL/min, lower than 150 mL/min, lower than 100 mL/min, or lower than 50 mL/min.

### Fourth Exemplary System and Method

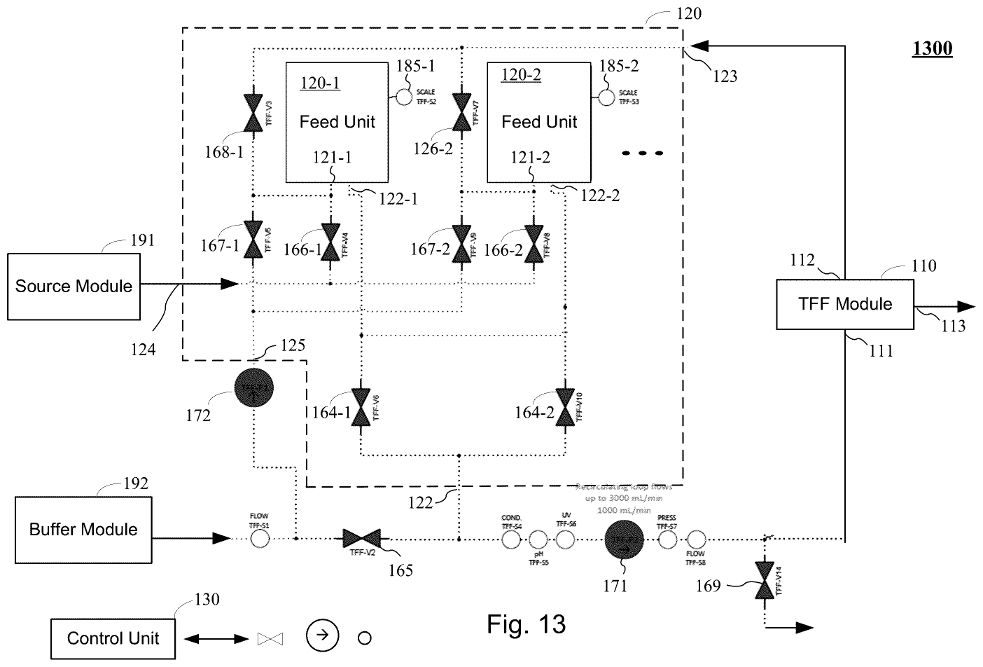

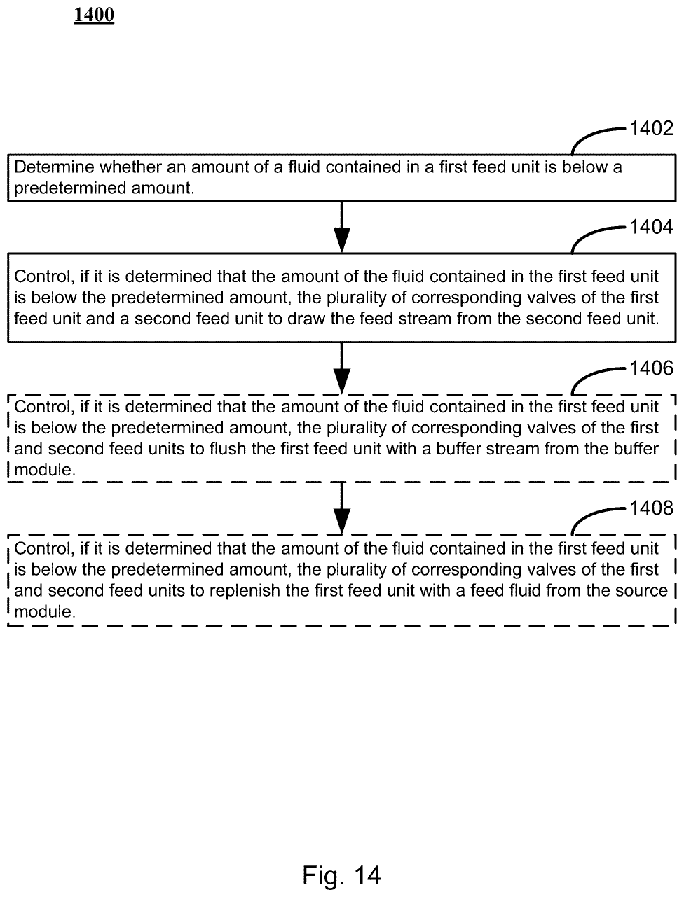

FIG. 13 is a block diagram illustrating a fourth exemplary system 1300, and FIG. 14 is a flowchart illustrating an exemplary method 1400 for automatically switching feed units to permit parallel processing of feed generation and feed separation in accordance with some embodiments of the present disclosure. The system 1300 and method 1400 are configured to automatically switch to another feed unit for providing a feed stream if the amount of feed fluid in the current feed unit is below a certain level. In some embodiments, additionally or optionally, the system 1300 and method 1400 are configured to prepare (e.g., clean, condition or prime) the used feed unit, and replenish the used feed unit with a feed fluid.

Referring to FIG. 13, the system 1300 includes a feed module 120 and a control unit 130. The feed module includes a first feed unit (e.g., one of the feed unit 120-1 and feed unit 120-2) and a second feed unit (e.g., the other of the feed unit 120-1 and feed unit 120-2). In some embodiments, except the first and second feed units, the feed module includes one or more additional feed units. The one or more additional feed units can be arranged the same as the first or second feed unit in terms of the fluidic connection to the TFF module, source module or buffer module. The one or more additional feed units can also be arranged differently than the first or second feed unit. For instance, an additional feed unit may not be fluidly connected to the source module or buffer module. Also, an addition feed unit may not be fluidly connected to the TFF module but instead may be fluidly connected to the first or second feed unit to provide the feed fluid to the first or second feed unit.

The feed unit 120-1 has an inlet 121-1 and an outlet 122-1. The inlet 121-1 is branched to at least three branches, with one fluidly connected to the retentate outlet 112 of the TFF module 110 through a valve 168-1, one fluidly connected to the source module 191 through a valve 166-1, and one fluidly connected to the buffer module 192 through a valve 167-1. The outlet 122-1 is fluidly connected to the feed inlet 111 of the TFF module 110 through a valve 164-1. A fifth sensor 185-1 is positioned and configured to measure an amount of a fluid (e.g., weight, volume, fluid level or the like) contained in the feed unit 120-1.

Similarly, the feed unit 120-2 has an inlet 121-2 and an outlet 122-2. The inlet 121-2 is branched to at least three branches, with one fluidly connected to the retentate outlet 112 of the TFF module 110 through a valve 168-2, one fluidly connected to the source module 191 through a valve 166-2, and one fluidly connected to the buffer module 192 through a valve 167-2. The outlet 122-2 is fluidly connected to the feed inlet 111 of the TFF module 110 through a valve 164-2. A fifth sensor 185-2 is positioned and configured to measure an amount of a fluid (e.g., weight, volume, fluid level or the like) contained in the feed unit 120-2.

In some embodiments, additionally or optionally, the system includes one or more other components. For instance, in some embodiments, the system includes a pump 172, e.g., a buffer pump, disposed in a flow path between the buffer module 192 and the buffer inlet-branch 125 of the feed module. That is, the pump 172 is fluidly connected to the outlet of the buffer module 192, the valve 187-1 of the feed unit 120-1 and the valve 187-2 of the feed unit 120-2, and can be used to draw a buffer stream from the buffer module and direct it to the feed unit 120-1 or the feed unit 120-2.

The control unit 130 is electrically connected to the valves and fifth sensors of the first and second feed units, and is configured to control the operation of the valves, and/or other components in the system such as the pump 172, based on the amount of the fluid measured by the fifth sensors. For instance, referring to block 1402 in FIG. 14, while the first feed unit (e.g., one of the feed unit 120-1 and feed unit 120-2) is supplying a feed stream to the TFF module for separation, the control unit 130 monitors the amount of the fluid contained in the first feed unit through the corresponding fifth sensor. It determines whether the amount of the fluid contained in the first feed unit is below a predetermined amount. The predetermined amount may be a minimal amount of the feed fluid that can provide an appropriate feed stream to the TFF module for sustainable separation process. The predetermined amount may also be a value set by a personnel (e.g., a person in charge of the system/process, or the like).

Referring to block 1404, when the amount of the fluid in the first feed unit is below the predetermined amount, the control unit controls the valves to draw a feed stream from the second feed unit (e.g., the other of the feed unit 120-1 and feed unit 120-2). For instance, while the feed unit 120-1 is supplying a feed stream to the TFF module, the control unit 130 obtains the amount of the fluid measured from the fifth sensor 185-1 and determines whether it is below a predetermined amount. If it is below a predetermined amount, the control unit closes the valve 164-1 to stop drawing the feed stream from the feed unit 120-1 and opens the valve 164-2 to start drawing the feed stream from the feed unit 120-2. The control unit also closes the valve 168-1 to stop sending the retentate stream to the feed unit 120-1 and opens the valve 168-2 to start sending the retentate stream to the feed unit 120-2. Similarly, while the feed unit 120-2 is supplying a feed stream to the TFF module, the control unit 130 obtains the amount of the fluid measured from the fifth sensor 185-2 and determines whether it is below a predetermined amount. If it is below a predetermined amount, the control unit closes the valve 164-2 to stop drawing the feed stream from the feed unit 120-2 and opens the valve 164-1 to start drawing the feed stream from the feed unit 120-1. The control unit also closes the valve 168-2 to stop sending the retentate stream to the feed unit 120-2 and opens the valve 168-1 to start sending the retentate stream to the feed unit 120-1. It should be noted that the predetermined amount for the first feed unit and the predetermined amount for the second feed unit may be the same or different.

Referring to block 1406, in some embodiments, additionally or optionally, when it is determined that the amount of the fluid contained in the first feed unit is below the predetermined amount, the control unit 130 controls the valves, and/or other components in the system such as the pump 172, to flush the first feed unit with a buffer stream from the buffer module. Flushing the first feed unit with a buffer stream will remove residual material from the previous cycle and prepare the first feed unit to receive the feed fluid again. For instance, while critical operations (e.g., concentration or diafiltration) of separation involve the feed unit 120-2, the control unit opens the valve 167-1 and closes valve 167-2 to direct a buffer stream from the buffer module 192 to the feed unit 120-1 to prepare it for receiving the feed fluid again. Similarly, while critical operations (e.g., concentration or diafiltration) of separation involve the feed unit 120-1, the control unit opens the valve 167-2 and closes valve 167-1 to direct a buffer stream from the buffer module 192 to the feed unit 120-2 to prepare it for receiving the feed fluid again.

Referring to block 1408, in some embodiments, additionally or optionally, when it is determined that the amount of the fluid contained in the first feed unit is below the predetermined amount, the control unit 130 controls the operation of the corresponding valves to replenish the first feed unit with a feed fluid from the source module. For instance, after flushing a buffer stream that prepares the feed unit 120-1 for receiving a feed fluid, the control unit closes the valve 167-1 and stops pumping a buffer stream to the feed unit 120-1. To replenish the feed unit 120-1 with a feed fluid, the control unit opens the valve 166-1 (and closes the valve 166-2 if it is opened) to start filling the feed unit 120-1 with the feed fluid from the source module 191. Similarly, after flushing a buffer stream that prepares the feed unit 120-2 for receiving a feed fluid, the control unit closes the valve 167-2 and stops pumping a buffer stream to the feed unit 120-2. To replenish the feed unit 120-2 with a feed fluid, the control unit opens the valve 166-2 (and closes the valve 166-1 if it is opened) to start filling the feed unit 120-2 with the feed fluid from the source module 191. As such, the process of feed separation can be operated in parallel (e.g., concurrently or overlapping) with the process of feed generation (e.g., a process occurred in the source module 191) whether their cyclic frequencies are the same or different.

### Fifth Exemplary System and Method

The features disclosed herein with respect to the first, second, third and fourth exemplary systems and methods can be combined in any suitable and meaningful ways. For instance, the features for maintaining a substantially constant permeate flow rate disclosed herein with respect to the first exemplary system and method (e.g., the use of the backpressure regulator 150) can be combined with the features for automatically switching TFF units disclosed herein with respect to the second exemplary system and method (e.g., the use of the second sensor 182, third sensor 183 and fourth sensor 184), with the features for promoting membrane recovery disclosed herein with respect to the third exemplary system and method (e.g., fluidic connection to the buffer module 192), with the features for automatically switching feed units to permit parallel processing disclosed herein with respect to the fourth exemplary system and method (e.g., the use of multiple feed units and/or fluidic connection to the source module), or any combination thereof. Similarly, the features for automatically switching TFF units disclosed herein with respect to the second exemplary system and method can be combined with the features for promoting membrane recovery disclosed herein with respect to the third exemplary system and method (e.g., fluidic connection to the buffer module 192), with the features for automatically switching feed units to permit parallel processing disclosed herein with respect to the fourth exemplary system and method (e.g., the use of multiple feed units and/or fluidic connection to the source module), or any combination thereof. In addition, the features for promoting membrane recovery disclosed herein with respect to the third exemplary system and method can be combined with the features for automatically switching feed units to permit parallel processing disclosed herein with respect to the fourth exemplary system and method (e.g., the use of multiple feed units and/or fluidic connection to the source module).

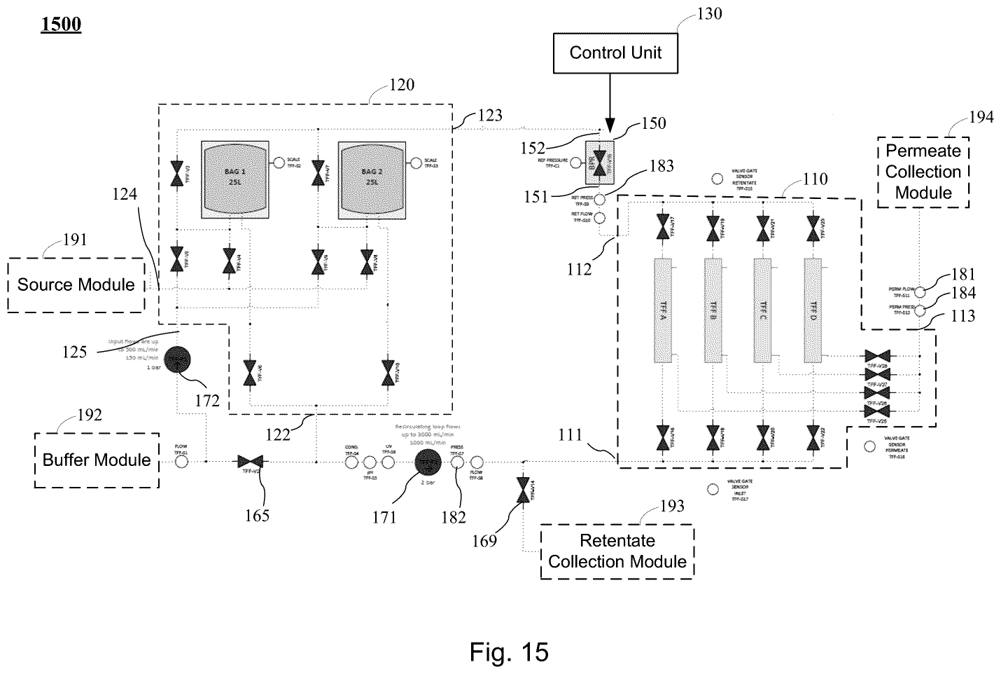

As a non-limiting example, FIG. 15 illustrated a fifth exemplary system 1500 for maintaining a substantially constant permeate flow rate, automatically switching TFF units, promoting membrane recovery, and automatically switching feed units to permit parallel processing. The system 1500 includes a TFF module 110, a feed module 120, a control unit 130, and a backpressure regulator 150. The system 1500 also includes a plurality of valves (e.g., the valves 161, 162, 163, 164, 165, 167 and 168), a plurality of pumps (e.g., the pumps 171 and 172), and a plurality of sensors (e.g., the sensors 181, 182, 183, 184 and 185). The control unit 130 is electrically connected to the plurality of valves, the plurality of pumps and the plurality of sensors.

The TFF module 110 includes a plurality of TFF units fluidly arranged in parallel. While FIG. 15 illustrates four TFF units, it should be noted that this is by way of example and is non-limiting. The TFF module can have 2, 3, 4, 5, 6, 7, 8 or more than 8 TFF units. The TFF module 110 has a feed inlet 111, a retentate outlet 112 and a permeate outlet 113. The feed inlet 11 of the TFF module is collectively defined by the feed inlets of the plurality of TFF units. Similarly, the retentate outlet 112 of the TFF module is collectively defined by the retentate outlets of the plurality of TFF units. The permeate outlet 113 of the TFF module is collectively defined by the permeate outlets of the plurality of TFF units.

The feed module 120 includes a plurality of feed units. While FIG. 15 illustrates two feed units, it should be noted that this is by way of example and is non-limiting. The feed module can have 2, 3, 4, 5, 6, 7, 8 or more than 8 feed units. The feed module 120 has an outlet 122, a retentate inlet-branch 123, a source inlet-branch 124 and a buffer inlet-branch 125. The outlet 122 of the feed module is collectively defined by the outlets of the plurality of feed units. Similarly, the retentate inlet-branch 123 is collectively defined by the retentate inlet-branches of the plurality of feed units. The source inlet-branch 124 is collectively defined by the source inlet-branches of the plurality of feed units. The buffer inlet-branch 125 is collectively defined by the buffer inlet-branches of the plurality of feed units.

The feed inlet 111 of the TFF module is fluidly connected to the outlet 122 of the feed module and fluidly connected to an outlet of a buffer module 192. The permeate outlet 122 of the TFF module is fluidly connected to a permeate collection 194. The retentate outlet 122 of the TFF module is fluidly connected to an inlet 151 of the backpressure regulator, while an outlet 152 of the backpressure regulator is fluidly connected to the retentate inlet-branch 123 of the feed module. The source inlet-branch 124 of the feed module is fluidly connected to a source module 191, and the buffer inlet-branch 125 of the feed module is fluidly connected to the buffer module 192.

The valves 161, 162 and 163 are disposed in flow paths within the TFF module in a manner the same as or similar to those disclosed herein with respect to FIG. 2B and the second exemplary system and method (e.g., FIG. 8). The valves 164, 166, 167 and 168 are disposed in flow paths within the feed module in a manner the same as or similar to those disclosed herein with respect to FIGS. 3A-3B, the third exemplary system and method (e.g., FIG. 11) and the fourth exemplary system and method (e.g., FIG. 13). The valve 165 is disposed in the flow path between the outlet of the buffer module 192 and the feed inlet 111 of the TFF module in a manner the same as or similar to that disclosed herein with respect to the third exemplary system and method (e.g., FIG. 11) and the fourth exemplary system and method (e.g., FIG. 13).

The pump 171 is disposed in a common flow path between the feed inlet 111 of the TFF module and the outlet 122 of the feed unit 120 and between the feed inlet 111 of the TFF module and the outlet of the buffer module in a manner the same as or similar to that disclosed herein with respect to the third exemplary system and method (e.g., FIG. 11) and the fourth exemplary system and method (e.g., FIG. 13). The pump 172 is disposed in a flow path between the buffer module 192 and the buffer inlet-branch 125 of the feed module in a manner the same as or similar to that disclosed herein with respect to the fourth exemplary system and method (e.g., FIG. 13).

The first sensor 181 is configured to measure a flow rate at the permeate outlet 113 of the TFF module. It is the same as or similar to those disclosed herein with respect to the first exemplary system and method (e.g., FIG. 5) and the second exemplary system and method (e.g., FIG. 8). The second sensor 182, third sensor 183 and fourth sensor 184 are configured to measure the pressures at the feed inlet 111, retentate outlet 112 and permeate outlet 113 of the TFF module. In some embodiments, there are a plurality of third sensors 183, each configured to measure a corresponding second pressure at the retentate outlet of each respective TFF unit in the plurality of TFF units. The second sensor 182, third sensor 183 and fourth sensor 184 are the same as or similar to those disclosed herein with respect to the first exemplary system and method (e.g., FIG. 5) and the second exemplary system and method (e.g., FIG. 8). The fifth sensor 185 is configured to measure the amount of a fluid in a feed unit in a manner the same as or similar to those disclosed herein with respect to the fourth exemplary system and method (e.g., FIG. 13).

The control unit 130 is electrically connected to the plurality of valves (e.g., the valves 161, 162, 163, 164, 165, 167 and 168), the plurality of pumps (e.g., the pumps 171 and 172), and the plurality of sensors (e.g., the sensors 181, 182, 183, 184 and 185), and configured to control the process of separation.

In some embodiments, the control unit 130 is configured to perform the exemplary method 600 to maintain a substantially constant flow rate at the permeate outlet of the TFF module. For instance, the control unit obtains the flow rate from the first sensor 181. Based on the flow rate measured by the first sensor, the control unit controls the backpressure regulator (e.g., altering the set point of the backpressure regulator)to adjust the TMP of the TFF module, and thus maintains a substantially constant flow rate at the permeate outlet of the TFF module.

In some embodiments, the control unit 130 is configured to perform the exemplary method 900 to automatically switch TFF units for separation. For instance, the control unit obtains the first pressure measured by the second sensor 182 at the feed inlet of the module, the second pressure(s) measured by the third sensor(s) 183 at the retentate outlet of the TFF module or at the retentate outlet of each TFF unit in a first set of TFF units that is being used for separation, and the third pressure measured by the fourth sensor 184 at the permeate outlet of the TFF module. The control unit calculates the TMP of the first set of TFF units based on the measured first, second and third pressures, and determine whether the TMP of the first set of TFF units exceeds a predetermined value. If it is determined that the TMP of the first set of TFF units exceeds the predetermined value, the control unit controls the valves, and other additional/optional components if present, to stop passing the feed stream to the first set of TFF units and to allow the feed stream to flow through a second set of TFF units in the plurality of TFF units. In some embodiments, based on the flow rate measured by the first sensor, the control unit 130 controls the backpressure regulator to adjust a TMP of the TFF module and thus maintains a first substantially constant permeate flow rate when the first set of TFF units is being used for separation and a second substantially constant permeate flow rate when the second set of TFF units is being used for separation. The first and second substantially constant permeate flow rates can be the same or different.

In some embodiments, the control unit 130 is configured to perform the exemplary method 1200 to promote membrane recovery. For instance, when the first or second set of TFF units has been used to process a certain amount of a feed fluid or used for a certain period of time, the control unit closes the valve 164 and open the valve 165 to draw a buffer stream from the buffer module and flow it through the TFF module. When the membrane(s) of the first or second set of TFF units is recovered or when a next batch of the feed fluid is ready to be processed, the control unit 130 closes the valve 165 to stop flowing the buffer stream to the TFF module.

In some embodiments, the control unit 130 is configured to perform the exemplary method 1400 to automatically switch feed units to permit parallel processing of feed generation and feed separation. For instance, in embodiments where a first feed unit (e.g., the feed unit 120-1) is involving critical operations of separation, the control unit monitors the amount of the fluid contained in the first feed unit through a corresponding fifth sensor (e.g., the fifth sensor 185-1), and determines whether the amount of the fluid contained in the first feed unit is below a predetermined amount. If it is determined that the amount of the fluid contained in the first feed unit is below the predetermined amount, the control unit controls the operation of the valves 164, 166, 167 and 168 of the first feed unit and a second feed unit (e.g., the feed unit 120-2) to draw the feed stream from the second feed unit. In some embodiments, additionally or optionally, when the amount of the fluid contained in the first feed unit is below the predetermined amount, the control unit controls the operation of the corresponding valves to flush the first feed unit with a buffer stream from the buffer module. In some embodiments, additionally or optionally, when the amount of the fluid contained in the first feed unit is below the predetermined amount, the control unit 130 controls the operation of the corresponding valves to replenish the first feed unit with a feed fluid from the source module.

### EXEMPLARY IMPLEMENTS

Implement 1. A system comprising: a tangential flow filtration (TFF) module comprising a feed inlet, a retentate outlet, and a permeate outlet, wherein the feed inlet of the TFF module is fluidly connected to an outlet of a first feed unit to receive a feed stream, and the permeate outlet of the TFF module is fluidly connected to a permeate collection module; a backpressure regulator, wherein an inlet of the backpressure regulator is fluidly connected to the retentate outlet of the TFF module, and an outlet of the backpressure regulator is fluidly connected to an inlet of the first feed unit; a first sensor configured to measure a flow rate at the permeate outlet of the TFF module; and a control unit electrically connected to the backpressure regulator and the first sensor, and configured to control the backpressure regulator based on the flow rate measured by the first sensor to adjust a transmembrane pressure (TMP) of the TFF module, thereby maintaining a first substantially constant flow rate at the permeate outlet of the TFF module.

Implement 2. The system of Implement 1, wherein the control of the backpressure regulator increases a pressure at the retentate outlet of the TFF module in response to a decrease of the flow rate measured by the first sensor, or decreases the pressure at the retentate outlet of the TFF module in response to an increase of the flow rate measured by the first sensor.

Implement 3. The system of Implement 2, wherein the control of the backpressure regulator comprises altering a set point of the backpressure regulator based on the flow rate measured by the first sensor.

Implement 4. The system of Implement 3, wherein the altering of the set point of the backpressure regulator comprises: raising the set point in response to the decrease of the flow rate measured by the first sensor; and lowering the set point in response to the increase of the flow rate measured by the first sensor.

Implement 5. The system of any one of Implements 1-4, wherein the TFF module consists of a single TFF unit.

Implement 6. The system of any one of Implements 1-4, wherein the TFF module comprises a plurality of TFF units arranged fluidly in parallel, wherein each respective TFF unit in the plurality of TFF units comprises: a corresponding individual feed inlet fluidly connected to the feed inlet of the TFF module; a corresponding individual retentate outlet fluidly connected to the retentate outlet of the TFF module; a corresponding individual permeate outlet fluidly connected to the permeate outlet of the TFF module; and at least one corresponding valve, wherein the at least one corresponding valve comprises a corresponding first valve coupled with the corresponding individual feed inlet. The control unit is electrically connected to the at least one corresponding valve of each of the plurality of TFF units, and configured to control the at least one corresponding valve of each of the plurality of TFF units to allow the feed stream to selectively flow through a first set of TFF units in the plurality of TFF units, wherein the control of the backpressure regulator adjusts the TMP of the first set of TFF units.

Implement 7. The system of Implement 6, wherein the plurality of TFF units comprises two, three, four, five, six, seven, eight, nine, ten or more than ten TFF units.

Implement 8. The system of Implement 6 or Implement 7, wherein for each respective TFF unit in the plurality of TFF units, the at least one corresponding valve further comprises a corresponding second valve coupled with the corresponding individual retentate outlet, a corresponding third valve coupled with the corresponding individual permeate outlet, or both.

Implement 9. The system of any one of Implements 6-8, wherein the first set of TFF units consists of a single TFF unit to filter the feed stream.

Implement 10. The system of any one of Implements 6-8, wherein the first set of TFF units comprises two or more TFF units, each to filter a portion of the feed stream.

Implement 11. The system of Implement 10, wherein the first set of TFF units consists of all of the plurality of TFF units.

Implement 12. The system of any one of Implements 7-11 further comprising:
a second sensor configured to measure a first pressure at the feed inlet of the TFF module; a plurality of third sensors, each configured to measure a corresponding second pressure at a corresponding retentate outlet of a corresponding TFF unit in the plurality of TFF units of the TFF module; and a fourth sensor configured to measure a third pressure at the permeate outlet of the TFF module, wherein the control unit is electrically connected to the second, third and fourth sensor, and is further configured to (i) calculate the TMP of the first set of TFF units based on the measured first pressure, the measured second pressure at the retentate outlet of each TFF unit in the first set of TFF units and the measured third pressures; (ii) determine whether the TMP of the first set of TFF units exceeds a predetermined value; and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

Implement 13. The system of Implement 12, wherein a pressure at the retentate outlet of the TFF module is obtained by averaging the second pressures measured at the retentate outlet of each TFF unit in the first set of TFF units.

Implement 14. The system of any one of Implements 7-11 further comprising: a second sensor configured to measure a first pressure at the feed inlet of the TFF module; a third sensor configured to measure a second pressure at the retentate outlet of the TFF module; and a fourth sensor configured to measure a third pressure at the permeate outlet of the TFF module, wherein the control unit is electrically connected to the second, third and fourth sensors, and is further configured to (i) calculate the TMP of the first set of TFF units based on the first, second and third pressures measured by the second, third and fourth sensors; (ii) determine whether the TMP of the first set of TFF units exceeds a predetermined value; and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

Implement 15. The system of Implement 14, wherein the control unit is further configured to control the backpressure regulator based on the flow rate measured by the first sensor to adjust a TMP of the second set of TFF units, thereby maintaining a second substantially constant flow rate at the permeate line of the TFF module.

Implement 16. The system of any one of Implements 14-15, wherein the second set of TFF units consists of a single TFF unit to filter the feed stream.

Implement 17. The system of any one of Implements 14-15, wherein the second set of TFF units comprises two or more TFF units, each to filter a portion of the feed stream.

Implement 18. The system of any one of the preceding Implements, wherein: the feed inlet of the TFF module is fluidly connected to the outlet of the first feed unit through a fourth valve, and fluidly connected to an outlet of a buffer module through a fifth valve; and the control unit is electrically connected to the fourth valve and the fifth valve and is further configured to control the fourth valve and the fifth valve to draw either the feed stream from the first feed unit or a buffer stream from the buffer module for flowing through the TFF module.

Implement 19. The system of Implement 18, wherein the feed stream and the buffer stream are drawn alternately.

Implement 20. The system of Implement 18 or Implement 19, wherein the feed stream is flowed through the TFF module for less than 50 hours, less than 45 hours, less than 40 hours, less than 35 hours, less than 30 hours, less than 25 hours, less than 20 hours, less than 15 hours, less than 10 hours, less than 5 hours, less than 4 hours, less than 3 hours, less than 2 hours, or less than 1 hour.

Implement 21. The system of any one of Implements 18-20, wherein the feed stream is flowed through the TFF module at a rate higher than 25 mL/min, higher than 50 mL/min, higher than 100 mL/min, higher than 200 mL/min, higher than 300 mL/min, higher than 400 mL/min, higher than 500 mL/min, higher than 1000 mL/min, higher than 2000 mL/min, higher than 3000 mL/min, higher than 4000 mL/min, or higher than 5000 mL/min.

Implement 22. The system of any one of Implements 18-21, wherein the buffer stream is flowed through the TFF module for more than 2 hours, more than 4 hours, more than 6 hours, more than 8 hours, more than 10 hours, more than 15 hours, more than 20 hours, or more than 25 hours.

Implement 23. The system of any one of Implements 18-22, wherein the feed stream is flowed through the TFF module at a rate lower than 500 mL/min, lower than 400 mL/min, lower than 300 mL/min, lower than 250 mL/min, lower than 200 mL/min, lower than 150 mL/min, lower than 100 mL/min, or lower than 50 mL/min.

Implement 24. The system of any one of the preceding Implements comprising: a plurality of feed units, wherein the plurality of feed units comprises the first feed unit and a second feed unit, wherein each respective feed unit in the first and second feed units comprises: a corresponding fourth valve connecting a corresponding individual outlet of the respective feed unit with the feed inlet of the TFF module; a corresponding sixth valve connecting a corresponding individual inlet of the respective feed unit with a source module; a corresponding seventh valve connecting the corresponding individual inlet of the respective feed unit with a buffer module; a corresponding eighth valve connecting the corresponding individual inlet of the respective feed unit with the outlet of the backpressure regulator; and a corresponding fifth sensor configured to measure an amount of a fluid contained in the respective feed unit, wherein the control unit is electrically connected to the corresponding fourth, sixth, seventh and eighth valves and the corresponding fifth sensor of each of the first and second feed units, and configured to (i) determine whether the amount of the fluid contained in the first feed unit is below a predetermined amount; and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

Implement 25. The system of Implement 24, wherein the control unit is further configured to: (iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module.

Implement 26. The system of Implement 24 or Implement 25, wherein the control unit is further configured to: (iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

Implement 27. The system of any one of Implements 24-26 further comprising: a buffer pump fluidly connected to the outlet of the buffer module and the corresponding seventh valve of each respective feed unit in the plurality of feed units.

Implement 28. The system of any one of the preceding Implements further comprising: a feed pump fluidly connected to the feed inlet of the TFF module, and fluidly connected to one or more of (i) the outlet of the first feed unit, (ii) the corresponding individual outlet of each respective feed unit in the plurality of feed units, (iii) the outlet of the buffer module.

Implement 29. The system of any one of the preceding Implements wherein the outlet of the first feed unit or the corresponding individual outlet of each respective feed unit in the plurality of feed units is connected to a retentate collection module by a configurable valve.

Implement 30. The system of any one of the preceding Implements wherein the control of the backpressure regulator includes monitoring the flow rate measured by the first sensor every 60 seconds or less, every 50 seconds or less, every 40 seconds or less, every 30 seconds or less, every 25 seconds or less, every 20 seconds or less, every 15 seconds or less, every 10 seconds or less, every 5 seconds or less, every 4 seconds or less, every 3 seconds or less, every 2 seconds or less, or every 1 seconds or less.

Implement 31. A system comprising: a tangential flow filtration (TFF) module comprising: a feed inlet of the TFF module fluidly connected to an outlet of a first feed unit to receive a feed stream; a retentate outlet of the TFF module fluidly connected to an inlet of the first feed unit; a permeate outlet of the TFF module fluidly connected to a permeate collection module; and a plurality of TFF units arranged fluidly in parallel. Each respective TFF unit in the plurality of TFF units comprises: a corresponding individual feed inlet fluidly connected to the feed inlet of the TFF module; a corresponding individual retentate outlet fluidly connected to the retentate outlet of the TFF module; a corresponding individual permeate outlet fluidly connected to the permeate outlet of the TFF module; and at least one corresponding valve, wherein the at least one corresponding valve comprises a corresponding first valve coupled with the corresponding individual feed inlet. The system further comprises a second sensor configured to measure a first pressure at the feed inlet of the TFF module; a third sensor configured to measure a second pressure at the retentate outlet of the TFF module; and a fourth sensor configured to measure a third pressure at the permeate outlet of the TFF module; and a control unit electrically connected to the at least one corresponding valve of each of the plurality of TFF units and the second, third and fourth sensors, wherein the feed stream is flowing through a first set of TFF units in the plurality of TFF units, and the control unit is configured to (i) calculate a TMP of the first set of TFF units based on the first, second and third pressures measured by the second, third and fourth sensors; (ii) determine whether the TMP of the first set of TFF units exceeds a predetermined value; and (iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

Implement 32. The system of Implement 31, wherein the first or second set of TFF units consists of a single TFF unit to filter the feed stream.

Implement 33. The system of Implement 31, wherein the first or second set of TFF units comprises two or more TFF units, each to filter a portion of the feed stream.

Implement 34. The system of any one of Implements 31-33, wherein: the feed inlet of the TFF module is fluidly connected to the outlet of the first feed unit through a fourth valve, and fluidly connected to an outlet of a buffer module through a fifth valve; and the control unit is electrically connected to the fourth valve and the fifth valve and is further configured to control the fourth valve and the fifth valve to draw either the feed stream from the first feed unit or a buffer stream from the buffer module for flowing through the TFF module.

Implement 35. The system of Implement 34, wherein the feed stream and the buffer stream are drawn alternately.

Implement 36. The system of Implement 35, wherein the feed stream is flowed through the TFF module for a first time period and the buffer stream is flowed through the TFF module for a second time period.

Implement 37. The system of Implement 36, wherein the first time period is less than 25 hours, less than 20 hours, less than 15 hours, less than 10 hours, less than 5 hours, less than 4 hours, less than 3 hours, less than 2 hours, or less than 1 hour.

Implement 38. The system of Implement 36 or Implement 37, wherein the second time period is more than 10 hours, more than 15 hours, more than 20 hours, or more than 25 hours.

Implement 39. The system of any one of Implements 35-38, wherein the feed stream is flowed through the TFF module at a first rate and the buffer stream is flowed through the TFF module at a second rate.

Implement 40. The system of Implement 40, wherein the first rate is higher than 500 mL/min, higher than 1000 mL/min, higher than 2000 mL/min, higher than 3000 mL/min, higher than 4000 mL/min, or higher than 5000 mL/min.

Implement 41. The system of Implement 39 or Implement 40, wherein the second rate is lower than 500 mL/min, lower than 400 mL/min, lower than 300 mL/min, lower than 250 mL/min, lower than 200 mL/min, or lower than 150 mL/min.

Implement 42. The system of any one of Implements 31-41 further comprising a plurality of feed units, wherein the plurality of feed units comprises the first feed unit and a second feed unit, wherein each respective feed unit in the first and second feed units comprises: a corresponding fourth valve connecting a corresponding individual outlet of the respective feed unit with the feed inlet of the TFF module; a corresponding sixth valve connecting a corresponding individual inlet of the respective feed unit with a source module; a corresponding seventh valve connecting the corresponding individual inlet of the respective feed unit with a buffer module; a corresponding eighth valve connecting the corresponding individual inlet of the respective feed unit with the retentate outlet of the TFF module; and a corresponding fifth sensor configured to measure an amount of a fluid contained in the respective feed unit. The control unit is electrically connected to the corresponding fourth, sixth, seventh and eighth valves and the corresponding fifth sensor of each of the first and second feed units, and configured to (i) determine whether the amount of the fluid contained in the first feed unit is below a predetermined amount; and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

Implement 43. The system of Implement 42, wherein the control unit is further configured to: (iii) control, if it is determined that the amount of the sample contained in the first feed unit is below the predetermined amount, the corresponding fourth, sixth, seventh and eighth valves of each of the first and second feed units to flush the first feed unit with a buffer stream from the buffer module.

Implement 44. The system of Implement 42 or Implement 43, wherein the control unit is further configured to: (iv) control, if it is determined that the amount of the sample contained in the first feed unit is below the predetermined amount, the corresponding fourth, sixth, seventh and eighth valves of each of the first and second feed units to replenish the first feed unit with a feed fluid from the source module.

Implement 45. The system of any one of Implements 42-44 further comprising a buffer pump fluidly connected to the outlet of the buffer module and the corresponding seventh valve of each respective feed unit in the plurality of feed units.

Implement 46. A system comprising a tangential flow filtration (TFF) module and a control unit. The TFF module comprises: a feed inlet fluidly connected to an outlet of a first feed unit through a fourth valve to receive a feed stream, and fluidly connected to an outlet of a buffer module through a fifth valve to receive a buffer stream; a retentate outlet fluidly connected to an inlet of the first feed unit; and a permeate outlet fluidly connected to a permeate collection module. The control unit is electrically connected to the fourth valve and the fifth valve and is configured to control the fourth valve and the fifth valve to draw either the feed stream from the first feed unit or the buffer stream from the buffer module for flowing through the TFF module.

Implement 47. The system of Implement 46, wherein the feed stream and the buffer stream are drawn alternately.

Implement 48. The system of Implement 47, wherein the feed stream is flowed through the TFF module for a first time period and the buffer stream is flowed through the TFF module for a second time period.

Implement 49. The system of Implement 48, wherein the first time period is less than 50 hours, less than 45 hours, less than 40 hours, less than 35 hours, less than 30 hours, less than 25 hours, less than 20 hours, less than 15 hours, less than 10 hours, less than 8 hours, less than 6 hours, less than 5 hours, less than 4 hours, less than 3 hours, less than 2 hours, or less than 1 hours.

Implement 50. The system of Implement 48 or Implement 49, wherein the second time period is more than 10 hours, more than 15 hours, more than 20 hours, more than 25 hours, more than 1 day, or more than 2 days.

Implement 51. The system of any one of Implements 46-50, wherein the feed stream is flowed through the TFF module at a first rate and the buffer stream is flowed through the TFF module at a second rate.

Implement 52. The system of Implement 51, wherein the first rate is higher than 25 mL/min, higher than 50 mL/min, higher than 100 mL/min, higher than 200 mL/min, higher than 300 mL/min, higher than 400 mL/min, higher than 500 mL/min, higher than 1000 mL/min, higher than 2000 mL/min, higher than 3000 mL/min, higher than 4000 mL/min, or higher than 5000 mL/min.

Implement 53. The system of Implement 51 or Implement 52, wherein the second rate is lower than 500 mL/min, lower than 400 mL/min, lower than 300 mL/min, lower than 250 mL/min, lower than 200 mL/min, lower than 150 mL/min, lower than 100 mL/min, or lower than 50 mL/min.

Implement 54. The system of any one of Implements 46-53 further comprising a plurality of feed units, wherein the plurality of feed units comprises the first feed unit and a second feed unit, wherein each respective feed unit in the first and second feed units comprises: a corresponding fourth valve connecting a corresponding individual outlet of the respective feed unit with a feed inlet of a tangential flow filtration (TFF) module; a corresponding sixth valve connecting a corresponding individual inlet of the respective feed unit with a source module; a corresponding seventh valve connecting the corresponding individual inlet of the respective feed unit with a buffer module; a corresponding eighth valve connecting the corresponding individual inlet of the respective feed unit with a retentate outlet of the TFF module; and a corresponding fifth sensor configured to measure an amount of a fluid contained in the respective feed unit. The control unit is electrically connected to the corresponding fourth, sixth, seventh and eighth valves and the corresponding fifth sensor of each of the first and second feed units, wherein the first feed unit is supplying the feed stream to the TFF module, and the control unit is configured to (i) determine whether the amount of the fluid contained in the first feed unit is below a predetermined amount; and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

Implement 55. The system of Implement 54, wherein the control unit is further configured to: (iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module.

Implement 56. The system of Implement 54 or Implement 55, wherein the control unit is further configured to: (iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

Implement 57. A system comprising a plurality of feed units and a control unit. The plurality of feed units comprises a first feed unit and a second feed unit, wherein each respective feed unit in the first and second feed units comprises: a corresponding fourth valve connecting a corresponding individual outlet of the respective feed unit with a feed inlet of a tangential flow filtration (TFF) module; a corresponding sixth valve connecting a corresponding individual inlet of the respective feed unit with a source module; a corresponding seventh valve connecting the corresponding individual inlet of the respective feed unit with a buffer module; a corresponding eighth valve connecting the corresponding individual inlet of the respective feed unit with a retentate outlet of the TFF module; and a corresponding fifth sensor configured to measure an amount of a fluid contained in the respective feed unit. The control unit is electrically connected to the corresponding fourth, sixth, seventh and eighth valves and the corresponding fifth sensor of each of the first and second feed units, wherein the first feed unit is supplying the feed stream to the TFF module, and the control unit is configured to (i) determine whether the amount of the fluid contained in the first feed unit is below a predetermined amount; and (ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

Implement 58. The system of Implement 57, wherein the control unit is further configured to: (iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module.

Implement 59. The system of Implement 57 or Implement 58, wherein the control unit is further configured to: (iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

Implement 60. The system of any one of Implements 57-59 further comprising: a buffer pump fluidly connected to the outlet of the buffer module and the corresponding seventh valve of each respective feed unit in the first and second feed units.

Implement 61. A method for controlling a system, wherein the system comprises a tangential flow filtration (TFF) module having a feed inlet fluidly connected to an outlet of a first feed unit to receive a feed stream and a retentate outlet fluidly connected to an inlet of a backpressure regulator, the method comprising: (A) obtaining a flow rate at a permeate outlet of the TFF module; and (B) controlling the backpressure regulator based on the obtained flow rate to adjust a transmembrane pressure (TMP) of the TFF module, thereby maintaining a substantially constant flow rate at the permeate outlet of the TFF module.

Implement 62. The method of Implement 61, wherein the control (B) of the backpressure regulator comprises: (B1) altering a set point of the backpressure regulator based on the obtained flow rate.

Implement 63. The method of Implement 62, wherein the altering (B1) of the set point of the backpressure regulator comprises: raising the set point in response to a decrease of the obtained flow rate; and lowering the set point in response to an increase of the obtained flow rate.

Implement 64. The method of any one of Implements 61-63, wherein the TFF module comprises a plurality of TFF units arranged fluidly in parallel and each respective TFF unit in the plurality of TFF units comprises at least one corresponding valve, the method further comprising: (C) controlling the at least one corresponding valve of each of the plurality of TFF units to allow the feed stream to selectively flow through a first set of TFF units in the plurality of TFF units, wherein the control (B) of the backpressure regulator adjusts the TMP of the first set of TFF units.

Implement 65. The method of Implement 64 further comprising: (D) obtaining a first pressure at the feed inlet of the TFF module, a second pressure at the retentate outlet of the TFF module, and a third pressure at the permeate outlet of the TFF module; (E) calculating the TMP of the first set of TFF units based on the first, second and third pressures; (F) determining whether the TMP of the first set of TFF units exceeds a predetermined value; and (G) controlling, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

Implement 66. The method of Implement 65, wherein the first or second set of TFF units consists of a single TFF unit to filter the feed stream.

Implement 67. The method of Implement 65, wherein the first or second set of TFF units comprises two or more TFF units, each to filter a portion of the feed stream.

Implement 68. The method of any one of Implements 61-67, wherein the feed inlet of the TFF module is fluidly connected to the outlet of the first feed unit through a fourth valve, and fluidly connected to an outlet of a buffer module through a fifth valve, the method further comprising: (H) controlling the fourth valve and the fifth valve to draw either the feed stream from the first feed unit or a buffer stream from the buffer module for flowing through the TFF module.

Implement 69. The method of Implement 68, wherein the feed stream and the buffer stream are drawn alternately.

Implement 70. The method of Implement 69, wherein the feed stream is flowed through the TFF module for a first time period and the buffer stream is flowed through the TFF module for a second time period.

Implement 71. The method of Implement 69 or Implement 70, wherein the feed stream is flowed through the TFF module at a first rate and the buffer stream is flowed through the TFF module at a second rate.

Implement 72. The method of any one of Implements 61-71, wherein the TFF module is fluidly connected to a plurality of feed units, the plurality of feed units comprising the first feed unit and a second feed unit, and each respective feed unit in the first and second feed units is fluidly connected to the TFF module, a source module and a buffer module through a plurality of corresponding valves, the method further comprising: (I) determining whether an amount of a fluid contained in the first feed unit is below a predetermined amount; and (J) controlling, if it is determined that the amount of the fluid contained in the first feed unit is below the predetermined amount, the plurality of corresponding valves of each of the first and second feed units to draw the feed stream from the second feed unit in the plurality of feed units.

Implement 73. The method of Implement 72 further comprising: (K) controlling, if it is determined that the amount of the fluid contained in the first feed unit is below the predetermined amount, the plurality of corresponding valves of each of the first and second feed units to flush the first feed unit with a buffer stream from the buffer module.

Implement 74. The method of Implement 72 or Implement 73 further comprising: (L) controlling, if it is determined that the amount of the fluid contained in the first feed unit is below the predetermined amount, the plurality of corresponding valves of each of the first and second feed units to replenish the first feed unit with a feed fluid from the source module.

Implement 75. A method for controlling a system, wherein the system comprises a tangential flow filtration (TFF) module having a plurality of TFF units arranged fluidly in parallel, each respective TFF unit in the plurality of TFF units comprises at least one corresponding valve, a feed inlet of the TFF module is fluidly connected to an outlet of a first feed unit to receive a feed stream that is flowing through a first set of TFF units in the plurality of TFF units, the method comprising: (A) obtaining a first pressure at the feed inlet of the TFF module, a second pressure at a retentate outlet of the TFF module, and a third pressure at a permeate outlet of the TFF module; (B) calculating the TMP of the first set of TFF units based on the first, second and third pressures; (C) determining whether the TMP of the first set of TFF units exceeds a predetermined value; and (D) controlling, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

Implement 76. The method of Implement 75, wherein the first or second set of TFF units consists of a single TFF unit to filter the feed stream.

Implement 77. The method of Implement 75, wherein the first or second set of TFF units comprises two or more TFF units, each to filter a portion of the feed stream.

Implement 78. The method of any one of Implements 75-77, wherein the feed inlet of the TFF module is fluidly connected to the outlet of the first feed unit through a fourth valve, and fluidly connected to an outlet of a buffer module through a fifth valve, the method further comprising: (E) controlling the fourth valve and the fifth valve to draw either the feed stream from the first feed unit or a buffer stream from the buffer module for flowing through the TFF module.

Implement 79. The method of Implement 78, wherein the feed stream and the buffer stream are drawn alternately.

Implement 80. The method of Implement 79, wherein the feed stream is flowed through the TFF module for a first time period and the buffer stream is flowed through the TFF module for a second time period.

Implement 81. The method of Implement 79 or Implement 80 the feed stream is flowed through the TFF module at a first rate and the buffer stream is flowed through the TFF module at a second rate.

Implement 82. The method of any one of Implements 75-81, wherein the system comprises a plurality of feed units, the plurality of feed units comprising the first feed unit and a second feed unit, and each respective feed unit in the first and second feed units is fluidly connected to the TFF module, a source module and a buffer module through a plurality of corresponding valves, the method further comprising: (F) determining whether an amount of a fluid contained in the first feed unit is below a predetermined amount; and (G) controlling, if it is determined that the amount of the fluid contained in the first feed unit is below the predetermined amount, the plurality of corresponding valves of each of the first and second feed units to draw the feed stream from the second feed unit in the plurality of feed units.

Implement 83. The method of Implement 82 further comprising: (H) controlling, if it is determined that the amount of the fluid contained in the first feed unit is below the predetermined amount, the plurality of corresponding valves of each of the first and second feed units to flush the first feed unit with a buffer stream from the buffer module.

Implement 84. The method of Implement 82 or Implement 83 further comprising: (I) controlling, if it is determined that the amount of the fluid contained in the first feed unit is below the predetermined amount, the plurality of corresponding valves of each of the first and second feed units to replenish the first feed unit with a feed fluid from the source module.

Implement 85. A method for controlling a system, wherein the system comprises a tangential flow filtration (TFF) module, and the TFF module comprises a feed inlet fluidly connected to an outlet of a first feed unit through a fourth valve to receive a feed stream and fluidly connected to an outlet of a buffer module through a fifth valve to receive a buffer stream, the method comprising: (A) controlling the fourth valve and the fifth valve to draw either the feed stream from the first feed unit or the buffer stream from the buffer module for flowing through the TFF module.

Implement 86. The method of Implement 85, wherein the feed stream and the buffer stream are drawn alternately.

Implement 87. The method of Implement 86, wherein the feed stream is flowed through the TFF module for a first time period and the buffer stream is flowed through the TFF module for a second time period.

Implement 88. The method of Implement 86 or Implement 87, wherein the feed stream is flowed through the TFF module at a first rate and the buffer stream is flowed through the TFF module at a second rate.

Implement 89. The method of any one of Implements 85-88, wherein the system comprises a plurality of feed units, the plurality of feed units comprising the first feed unit and a second feed unit, and each respective feed unit in the first and second feed units is fluidly connected to the TFF module, a source module and a buffer module through a plurality of corresponding valves, the method further comprising: (B) determining whether an amount of a fluid contained in the first feed unit is below a predetermined amount; and (C) controlling, if it is determined that the amount of the fluid contained in the first feed unit is below the predetermined amount, the plurality of corresponding valves of each of the first and second feed units to draw the feed stream from the second feed unit in the plurality of feed units.

Implement 90. The method of Implement 89 further comprising: (D) controlling, if it is determined that the amount of the fluid contained in the first feed unit is below the predetermined amount, the plurality of corresponding valves of each of the plurality of feed units to flush the first feed unit with a buffer stream from the buffer module.

Implement 91. The method of Implement 89 or Implement 90 further comprising: (E) controlling, if it is determined that the amount of the fluid contained in the first feed unit is below the predetermined amount, the plurality of corresponding valves of each of the plurality of feed units to replenish the first feed unit with a feed fluid from the source module.

Implement 92. A method for controlling a system, wherein the system comprises a plurality of feed units, the plurality of feed units comprises a first feed unit and a second unit, each respective feed unit in the first and second feed units is fluidly connected to a TFF module, a source module and a buffer module through a plurality of corresponding valves, and the first feed unit is supplying a feed stream to the TFF module, the method comprises:(A) determining whether an amount of a fluid contained in the first feed unit is below a predetermined amount; and (B) controlling, if it is determined that the amount of the fluid contained in the first feed unit is below the predetermined amount, the plurality of corresponding valves of each of the first and second feed units to draw the feed stream from a second feed unit in the first and second feed units.

Implement 93. The method of Implement 92 further comprising: (C) controlling, if it is determined that the amount of the fluid contained in the first feed unit is below the predetermined amount, the plurality of corresponding valves of each of the first and second feed units to flush the first feed unit with a buffer stream from the buffer module.

Implement 94. The method of Implement 92 or Implement 93 further comprising: (D) controlling, if it is determined that the amount of the fluid contained in the first feed unit is below the predetermined amount, the plurality of corresponding valves of each of the first and second feed units to replenish the first feed unit with a feed fluid from the source module.

The systems and methods of the present invention can include other additional, optional or alternative components. For instance, a system (e.g., system 100, system 500, system 800, system 1100, system 1300, or system 1500) may include a sensor configured to measure a flow rate of the buffer stream, a sensor configured to measure a flow rate at the feed inlet of the TFF module, a sensor configured to measure a flow rate at the retentate outlet of the TFF module, a sensor configured to measure an acidity or alkalinity of the feed stream, a sensor to measure a position of a valve (e.g., whether a valve is open or closed, or the degree of opening), a module for sampling a feed fluid between the source module and the feed module, or any combination thereof.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

What is claimed is:

1. A system comprising:
a tangential flow filtration (TFF) module comprising a feed inlet, a retentate outlet, and a permeate outlet, wherein the feed inlet of the TFF module is fluidly connected to an outlet of a first feed unit to receive a feed stream, and the permeate outlet of the TFF module is fluidly connected to a permeate collection module;
a backpressure regulator, wherein an inlet of the backpressure regulator is fluidly connected to the retentate outlet of the TFF module, and an outlet of the backpressure regulator is fluidly connected to an inlet of the first feed unit;
a first sensor configured to measure a flow rate at the permeate outlet of the TFF module; and
a control unit electrically connected to the backpressure regulator and the first sensor, and configured to control the backpressure regulator based on the flow rate measured by the first sensor to adjust a transmembrane pressure (TMP) of the TFF module, thereby maintaining a first substantially constant flow rate at the permeate outlet of the TFF module.

2. The system of claim 1, wherein the control of the backpressure regulator increases a pressure at the retentate outlet of the TFF module in response to a decrease of the flow rate measured by the first sensor, or decreases the pressure at the retentate outlet of the TFF module in response to an increase of the flow rate measured by the first sensor.

3. The system of claim 2, wherein the control of the backpressure regulator comprises altering a set point of the backpressure regulator based on the flow rate measured by the first sensor.

4. The system of claim 3, wherein the altering of the set point of the backpressure regulator comprises:
raising the set point in response to the decrease of the flow rate measured by the first sensor; and
lowering the set point in response to the increase of the flow rate measured by the first sensor.

5. The system of claim 1, wherein the TFF module consists of a single TFF unit.

6. The system of claim 1, wherein:
the TFF module comprises a plurality of TFF units arranged fluidly in parallel, wherein each respective TFF unit in the plurality of TFF units comprises:
a corresponding individual feed inlet fluidly connected to the feed inlet of the TFF module;
a corresponding individual retentate outlet fluidly connected to the retentate outlet of the TFF module;
a corresponding individual permeate outlet fluidly connected to the permeate outlet of the TFF module; and
at least one corresponding valve, wherein the at least one corresponding valve comprises a corresponding first valve coupled with the corresponding individual feed inlet; and
the control unit is electrically connected to the at least one corresponding valve of each of the plurality of TFF units, and configured to control the at least one corresponding valve of each of the plurality of TFF units to allow the feed stream to selectively flow through a first set of TFF units in the plurality of TFF units, wherein the control of the backpressure regulator adjusts the TMP of the first set of TFF units.

7. The system of claim 6, wherein for each respective TFF unit in the plurality of TFF units, the at least one corresponding valve further comprises a corresponding second valve coupled with the corresponding individual retentate outlet, a corresponding third valve coupled with the corresponding individual permeate outlet, or both.

8. The system of claim 6, wherein the first set of TFF units consists of a single TFF unit to filter the feed stream.

9. The system of claim 6, wherein the first set of TFF units comprises two or more TFF units, each to filter a portion of the feed stream.

10. The system of claim 6 further comprising:
a second sensor configured to measure a first pressure at the feed inlet of the TFF module;
a plurality of third sensors, each configured to measure a corresponding second pressure at a corresponding retentate outlet of a corresponding TFF unit in the plurality of TFF units of the TFF module; and
a fourth sensor configured to measure a third pressure at the permeate outlet of the TFF module,
wherein the control unit is electrically connected to the second, third and fourth sensor, and is further configured to
(i) calculate the TMP of the first set of TFF units based on the measured first pressure, the measured second pressure at the retentate outlet of each TFF unit in the first set of TFF units and the measured third pressures;
(ii) determine whether the TMP of the first set of TFF units exceeds a predetermined value; and
(iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

11. The system of claim 10, wherein a pressure at the retentate outlet of the TFF module is obtained by averaging the second pressures measured at the retentate outlet of each TFF unit in the first set of TFF units.

12. The system of claim 6 further comprising:
a second sensor configured to measure a first pressure at the feed inlet of the TFF module;
a third sensor configured to measure a second pressure at the retentate outlet of the TFF module; and
a fourth sensor configured to measure a third pressure at the permeate outlet of the TFF module,
wherein the control unit is electrically connected to the second, third and fourth sensors, and is further configured to
(i) calculate the TMP of the first set of TFF units based on the first, second and third pressures measured by the second, third and fourth sensors;
(ii) determine whether the TMP of the first set of TFF units exceeds a predetermined value; and
(iii) control, if it is determined that the TMP of the first set of TFF units exceeds the predetermined value, the at least one corresponding valve of each of the plurality of TFF units to stop passing the feed stream to the first set of TFF units and to allow the feed stream to flow through a second set of TFF units in the plurality of TFF units.

13. The system of claim 12, wherein the control unit is further configured to control the backpressure regulator based on the flow rate measured by the first sensor to adjust a TMP of the second set of TFF units, thereby maintaining a second substantially constant flow rate at the permeate line of the TFF module.

14. The system of claim 1, wherein:
the feed inlet of the TFF module is fluidly connected to the outlet of the first feed unit through a fourth valve, and fluidly connected to an outlet of a buffer module through a fifth valve; and
the control unit is electrically connected to the fourth valve and the fifth valve and is further configured to control the fourth valve and the fifth valve to draw either the feed stream from the first feed unit or a buffer stream from the buffer module for flowing through the TFF module.

15. The system of claim 14, wherein the feed stream and the buffer stream are drawn alternately.

16. The system of claim 1 comprising:
a plurality of feed units, wherein the plurality of feed units comprises the first feed unit and a second feed unit, wherein each respective feed unit in the first and second feed units comprises:
a corresponding fourth valve connecting a corresponding individual outlet of the respective feed unit with the feed inlet of the TFF module;
a corresponding sixth valve connecting a corresponding individual inlet of the respective feed unit with a source module;
a corresponding seventh valve connecting the corresponding individual inlet of the respective feed unit with a buffer module;
a corresponding eighth valve connecting the corresponding individual inlet of the respective feed unit with the outlet of the backpressure regulator; and
a corresponding fifth sensor configured to measure an amount of a fluid contained in the respective feed unit,
wherein the control unit is electrically connected to the corresponding fourth, sixth, seventh and eighth valves and the corresponding fifth sensor of each of the first and second feed units, and configured to
(i) determine whether the amount of the fluid contained in the first feed unit is below a predetermined amount; and
(ii) control, if it is determined that the amount of the fluid contained in the first feed unit is below the predetermined amount, the corresponding fourth, sixth, seventh and eighth valves of each of the first and second feed units to draw the feed stream from the second feed unit in the plurality of feed units.

17. The system of claim 16, wherein the control unit is further configured to:
(iii) control, if it is determined that the amount of the fluid contained in the first feed unit is below the predetermined amount, the corresponding fourth, sixth, seventh and eighth valves of each of the first and second feed units to flush the first feed unit with a buffer stream from the buffer module.

18. The system of claim 16, wherein the control unit is further configured to:
(iv) control, if it is determined that the amount of the fluid contained in the first feed unit is below the predetermined amount, the corresponding fourth, sixth, seventh and eighth valves of each of the first and second feed units to replenish the first feed unit with a feed fluid from the source module.

19. The system of claim 16 further comprising:
a buffer pump fluidly connected to the outlet of the buffer module and the corresponding seventh valve of each respective feed unit in the plurality of feed units.

20. The system of claim 1 further comprising:
a feed pump fluidly connected to the feed inlet of the TFF module, and fluidly connected to one or more of (i) the outlet of the first feed unit, (ii) the corresponding individual outlet of each respective feed unit in a plurality of feed units, (iii) the outlet of a buffer module.
